(19) United States
(12) Patent Application Publication
(10) Pub. No.: US 2026/0015872 A1
(43) Pub. Date: Jan. 15, 2026

(54) COMPOSITE BOARD

(71) Applicant: Trex Company, Inc., Winchester, VA (US)

(72) Inventors: Jamie TALBERT, Frederick, MD (US); Darren W. GARRISON, Capon Bridge, WV (US)

(73) Assignee: Trex Company, Inc., Winchester, VA (US)

(21) Appl. No.: 19/264,144

(22) Filed: Jul. 9, 2025

Related U.S. Application Data
(60) Provisional application No. 63/671,636, filed on Jul. 15, 2024.
(60) Provisional application No. 63/823,587, filed on Jun. 13, 2025.

(51) Int. Cl. E04F 15/10; B32B 3/06; B32B 3/12; B32B 3/28; B32B 3/30; B32B 27/20; B32B 27/32; E04F 15/02

(52) U.S. Cl. CPC E04F 15/107; B32B 3/06; B32B 3/12; B32B 3/28; B32B 3/30; B32B 27/20; B32B 27/32; B32B 2250/03; B32B 2250/40; B32B 2264/067; B32B 2419/00; E04F 15/02044; E04F 2015/02122

(57) ABSTRACT

A panel comprising a honeycomb core is disclosed. In various embodiments, the honeycomb core is comprised of a folded material. In certain embodiments, the honeycomb core is comprised of an extruded material. A panel comprising a core comprised of a dimpled material is also disclosed. In at least one embodiment, the core is comprised of polyethylene and wood embedded in the polyethylene. The core comprises a first face and a second face opposite the first face and the deck board further comprises a first layer attached to the first face and a second layer attached to the second face. In various embodiments, the first layer and the second layer are thermally bonded to the core during a continuous manufacturing process. The panel can further comprise a decorative and/or performance layer bonded to the second layer.

### CROSS REFERENCE TO RELATED APPLICATIONS

This application claims the benefit of U.S. Provisional Patent Application No. 63/671,636, entitled COMPOSITE BOARD, which was filed on Jul. 15, 2024, and U.S. Provisional Patent Application No. 63/823,587, entitled COMPOSITE PANEL, which was filed on Jun. 13, 2025, the entire disclosures of which are incorporated by reference.

### BACKGROUND

A deck is an architectural structure that is typically elevated above the surrounding ground level of a building to extend the living space of the building to the outdoors and/or provide users with a space on which to relax, eat, and perform other activities. Decking can be made from many materials, such as wood and/or manufactured composite materials, for example. In many instances, it is desirable for decking comprised of manufactured composite materials to mimic the structural characteristics of decking comprised of wood. In some instances, however, deck planks, for example, made from manufactured composite materials can be heavier, if not much heavier, than their wood counterparts. In many instances, one or more fascia panels are attached to the deck structure, such as deck planks, for example, to provide a desired appearance. Moreover, in many instances, a trim piece can be used to cover one or more edges and/or sides of a deck structure and/or fascia panel, for example.

### SUMMARY

In one form, the present invention comprises a manufactured deck board comprising a core comprised of honeycomb cells, wherein the core comprises a first face and a second face opposite the first face, a first layer attached to the first face, and a second layer attached to the second face.

In one form, the present invention comprises a manufactured deck board comprising a core comprised of a folded material, wherein the core comprises a first face and a second face opposite the first face, a first layer attached to the first face, and a second layer attached to the second face.

In one form, the present invention comprises a manufactured deck board comprising a core comprised of a dimpled material, wherein the core comprises a first face and a second face opposite the first face, a first layer attached to the first face, and a second layer attached to the second face.

In one form, the present invention comprises a method for manufacturing a deck board comprising folding a material to create a honeycomb core, the honeycomb core comprising a first face, a second face, and cells defined by cell walls, bonding a first layer to the first face, and bonding a second layer to the second face.

In one form, the present invention comprises a method for manufacturing a deck board comprising thermoforming a material to create a dimpled core, the dimpled core comprising a first face and a second face, bonding a first layer to the first face, and bonding a second layer to the second face.

In one form, the present invention comprises a fascia panel comprising a core comprised of honeycomb cells, wherein the core comprises a first face and a second face opposite the first face, a first layer attached to the first face, and a second layer attached to the second face.

In one form, the present invention comprises a fascia panel comprising a core comprised of a folded material, wherein the core comprises a first face and a second face opposite the first face, a first layer attached to the first face, and a second layer attached to the second face.

In one form, the present invention comprises a fascia panel comprising a core comprised of a dimpled material, wherein the core comprises a first face and a second face opposite the first face, a first layer attached to the first face, and a second layer attached to the second face.

In one form, the present invention comprises a method for manufacturing a fascial panel comprising folding a material to create a honeycomb core, the honeycomb core comprising a first face, a second face, and cells defined by cell walls, bonding a first layer to the first face, and bonding a second layer to the second face.

In one form, the present invention comprises a method for manufacturing a fascia panel comprising thermoforming a material to create a dimpled core, the dimpled core comprising a first face and a second face, bonding a first layer to the first face, and bonding a second layer to the second face.

In one form, the present invention comprises trim comprising a core comprised of honeycomb cells, wherein the core comprises a first face and a second face opposite the first face, a first layer attached to the first face, and a second layer attached to the second face.

In one form, the present invention comprises trim comprising a core comprised of a folded material, wherein the core comprises a first face and a second face opposite the first face, a first layer attached to the first face, and a second layer attached to the second face.

In one form, the present invention comprises trim comprising a core comprised of a dimpled material, wherein the core comprises a first face and a second face opposite the first face, a first layer attached to the first face, and a second layer attached to the second face.

In one form, the present invention comprises a method for manufacturing trim comprising folding a material to create a honeycomb core, the honeycomb core comprising a first face, a second face, and cells defined by cell walls, bonding a first layer to the first face, and bonding a second layer to the second face.

In one form, the present invention comprises a method for manufacturing trim comprising thermoforming a material to create a dimpled core, the dimpled core comprising a first face and a second face, bonding a first layer to the first face, and bonding a second layer to the second face.

### BRIEF DESCRIPTION OF THE DRAWINGS

The features of the exemplary embodiments of the present invention will be described with reference to the following drawings, where like elements are labeled similarly, and in which:

FIG. 1 is perspective view of a decking system;

FIG. 2 is a detail view of area II of the decking system of FIG. 1;

FIG. 3 illustrates a deck board being aligned with a deck frame to create the decking system of FIG. 1;

FIG. 4 is a partial cross-sectional perspective view of a manufactured board comprising a core including a dimpled sheet;

FIG. 5 is a partial cross-sectional perspective view of a manufactured board comprising a core including a plurality of dimpled sheets;

FIG. 6 is a partial cross-sectional perspective view of a manufactured board comprising a core having a honeycomb configuration;

FIG. 7 is a partial cross-sectional perspective view of a manufactured board comprising a core having a folded honeycomb configuration;

FIG. 7A is a plan view of the core of FIG. 7;

FIG. 8 is a partial cross-sectional elevational view of a manufactured board comprising a core having a honeycomb configuration;

FIG. 9 is a partial cross-sectional elevational view of a manufactured board comprising a core and a banded edge;

FIG. 10 is a partial cross-sectional elevational view of a manufactured board comprising a core and a wrap shell;

FIG. 11 is a partial cross-sectional elevational view of a manufactured board comprising a core and an attached edge profile;

FIG. 12 is a partial cross-sectional elevational view of a manufactured board comprising a core and a groove cut in a lateral edge of the core;

FIG. 13 is a partial cross-sectional view of the manufactured board of FIG. 12 comprising an attached edge profile;

FIG. 14 is a partial cross-sectional view of a manufactured board comprising a core and an attached edge profile shell;

FIG. 15 is a partial cross-sectional view of a manufactured board comprising a thermoformed rounded edge;

FIG. 16 is a partial cross-sectional view of a manufactured board comprising a thermoformed pinched edge;

FIG. 17 is a partial cross-sectional view of a manufactured board comprising a thermoformed profiled edge;

FIG. 18A is a side view of a core for a manufactured board;

FIG. 18B depicts a manufacturing process for making the core of FIG. 18A;

FIG. 18C depicts cut lines for cutting the core of FIG. 18A from a sheet and/or cutting a manufactured board including the core of FIG. 18A from a sheet;

FIG. 19A depicts the core of FIG. 18A and extruded layers being applied to the core by a manufacturing process to create a continuous composite sheet;

FIG. 19B depicts extruded layers being applied to the core of FIG. 18A by an in-line co-extrusion manufacturing process to create a continuous composite sheet;

FIG. 19C depicts a layer being extruded directly onto the core of FIG. 18A by a manufacturing process to create a continuous composite sheet;

FIG. 20A depicts an extruded layer being applied to one of the extruded layers of FIG. 19A, 19B, or 19C, by a manufacturing process to create a continuous composite sheet having an additional layer;

FIG. 20B depicts an extruded layer being applied to one of the extruded layers of FIG. 19A, 19B, or 19C, by an in-line co-extrusion manufacturing process to create a continuous composite sheet having an additional layer;

FIG. 20C depicts a layer being extruded directly onto one of the extruded layers of FIG. 19A, 19B, or 19C, by a manufacturing process to create a continuous composite sheet;

FIG. 21 depicts a manufacturing process for creating a continuous composite sheet;

FIG. 22 depicts a sheet of material being folded to create a core during a manufacturing process that can be used to produce the core of FIGS. 7 and 7A;

FIG. 23 depicts folding equipment that can be used to produce the core of FIGS. 7 and 7A;

FIG. 24 depicts successive in-line steps in a continuous decking plank, or board, production line;

FIG. 25 depicts a belt press that can be used to thermally laminate a layer to a core;

FIG. 26 depicts an outer layer mechanically attached to a core;

FIG. 27 is a front view of a fascia panel;

FIG. 28 is a rear view of the fascia panel of FIG. 27;

FIG. 29 is a perspective view of the fascia panel of FIG. 27; and

FIG. 30 depicts trim used in connection with the fascia panel of FIG. 27.

Parts given a reference numerical designation in one figure may be considered to be the same parts where they appear in other figures without a numerical designation unless specifically labeled with a different part number and described herein.

### DETAILED DESCRIPTION

The features and benefits of the present invention are illustrated and described herein by reference to exemplary embodiments. This description of exemplary embodiments is intended to be read in connection with the accompanying drawings, which are to be considered part of the entire written description. Accordingly, the disclosure expressly should not be limited to such exemplary embodiments illustrating some possible non-limiting combination of features that may exist alone or in other combinations of features.

In the description of embodiments disclosed herein, any reference to direction or orientation is merely intended for convenience of description and is not intended in any way to limit the scope of the present invention. Relative terms such as “lower,” “upper,” “horizontal,” “vertical,”, “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation. Terms such as “attached,” “affixed,” “connected,” “coupled,” “interconnected,” and similar terms refer to a relationship wherein structures are secured or attached to one another either directly or indirectly through intervening structures, as well as both movable or rigid attachments or relationships, unless expressly described otherwise.

As used throughout, any ranges disclosed herein are used as shorthand for describing each and every value that is within the range. Any value within the range can be selected as the terminus of the range.

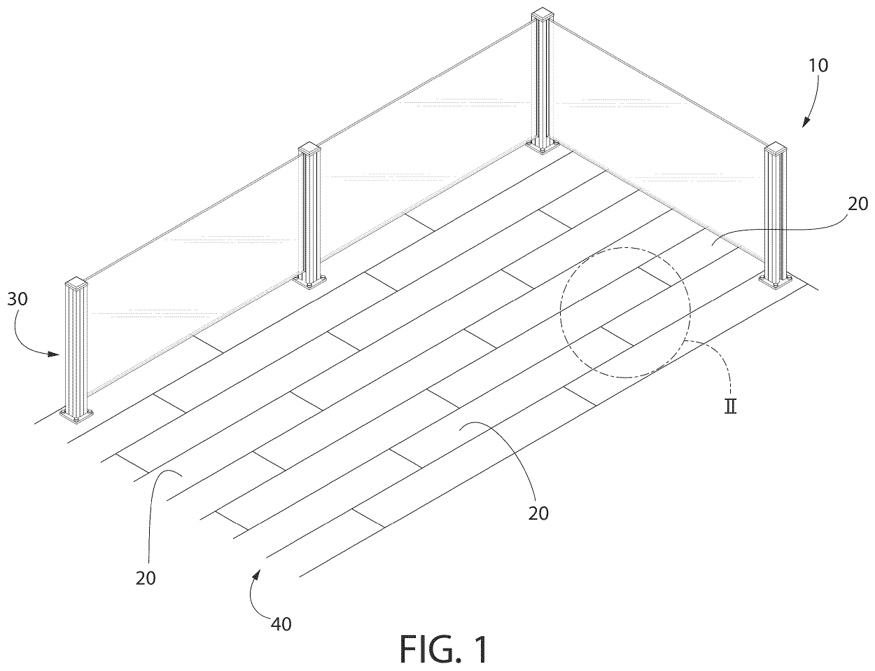

FIGS. 1-3 illustrate a decking system 10 comprising a plurality of boards, or decking planks, 20 that are arranged in a desired pattern and fastened to one or more supports or support structures 50 located below the boards 20. The boards 20 collectively form a deck platform, or deck, 40 upon which furniture may be placed and/or users may stand, for instance. In FIG. 1, the boards 20 are arranged in a staggered horizontal pattern, for example; however, any suitable pattern may be used such as diagonal patterns, vertical patterns, patchwork patterns, and/or herringbone patterns, for example. The decking system 10 further comprises a railing system 30 positioned along the perimeter of the deck 40 formed by the boards 20.

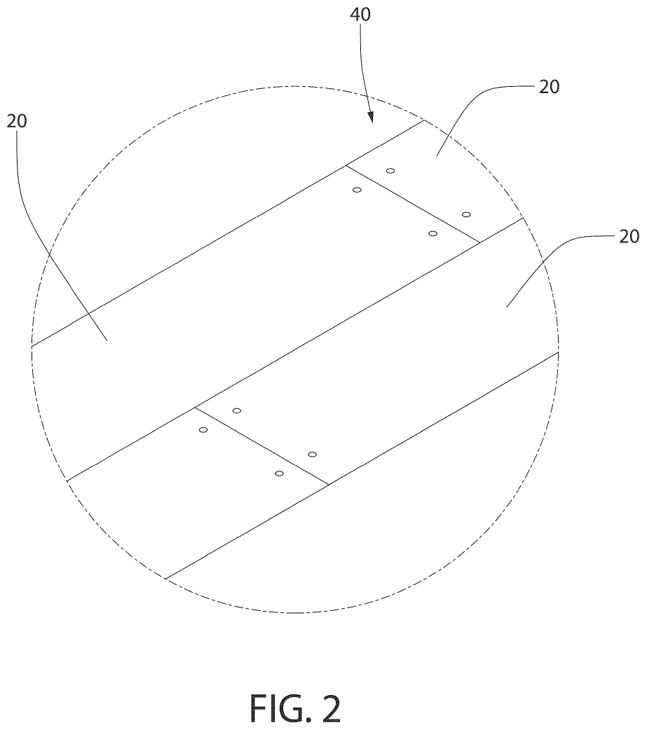

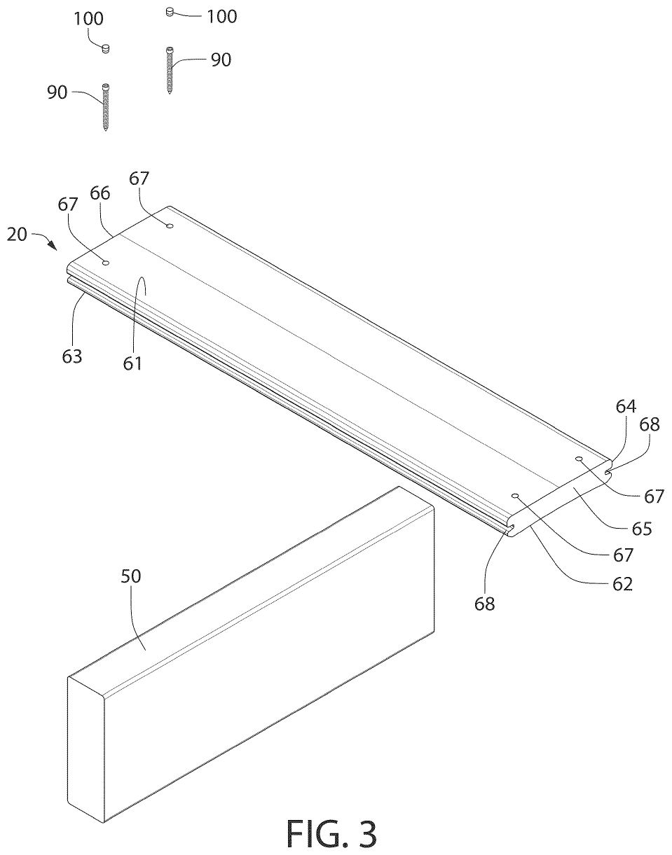

Further to the above, the boards 20 have a rectangular shape, for example, but can have any suitable shape, such as square shapes, triangular shapes, hexagonal shapes, other polygonal shapes, non-polygonal shapes, and/or irregular shapes, for example. The boards 20 of the decking system 10 need not all have the same shape and, in many instances, boards 20 having different shapes may be used within a singular decking system 10. In various instances, referring to FIG. 2, fasteners 90 may be used to fasten the boards 20 to the underlying support structures 50 of the decking system 10. The fasteners 90 may comprise screws, nails, bolts, staples, and/or any other suitable hardware, for example. In at least some instances, holes, such as pilot holes 67, for example, can be drilled in the boards 20 to accommodate the fasteners. In some instances, the fasteners can comprise self-drilling features that drill into the boards 20 and/or the underlying support structures 50. In various instances, the fasteners can be driven into the boards 20 such that the heads of the fasteners are recessed relative to the top surface of the deck 40. In at least some instances, recesses can be countersunk in the top surface of the deck 40 around the holes 67 that are configured to receive the heads of the fasteners. In various instances, referring to FIG. 3, plugs 99, for example, can be inserted into such holes and/or recesses which can provide a pleasing aesthetic appearance.

The support structures 50 are formed from wood, although any suitable materials may be used such as composite materials, engineered wood products, and/or various hard plastics, for example. The support structures 50 may comprise beams, bridging, and/or joists that collectively, and/or individually, support the boards 20. In many instances, the support structures 50 comprise boards. In various embodiments, the boards 20 comprise a solid, non-hollow structure. In certain embodiments, each board 20 comprises a core and a cap or shell, with the cap or shell being extruded onto a surface of the core during an extrusion process. In such instances, the core and the cap/shell form a combined composite structure in lieu of separate parts. Each board 20 comprises a top surface 61, a bottom surface 62, a first side surface 63, and a second side surface 64. Each board 20 further comprises rounded corners between the top surface 61 and each of the first and second side surfaces 63, 64 and between the bottom surface 62 and each of the first and second side surfaces 63, 64. Each board 20 further comprises a first end 65 and a second end 66, with the boards 20 being elongated in a longitudinal direction between the first and second ends 65, 66.

In many instances, further to the above, the boards 20 are arranged in a side-by-side manner with the side surfaces 63 and 64 of adjacent boards 20 in close proximity to one another, if not abutting one another in some instances. The first and second side surfaces 63, 64 of certain boards 20 comprise grooves, or slots, 68 defined therein that are configured to receive fastener clips. Each fastener clip comprises a lock shoulder configured to engage a shoulder of a groove 68 when the fastener clip is fastened to an underlying support structure 50. As a result of the above, the fastener clips mount the boards 20 to the support structure 50 and hold the boards 20 in position. Such fastener clips can be used in addition to or in lieu of the fasteners 90 discussed above. Some boards 20 may not have grooves 68 defined therein. In many instances, such boards 20 without grooves 68 can be used along the perimeter of the decking system 10, for instance.

In various embodiments, the cores of the boards 20 are formed from a composite composition comprising a polymeric material and a cellulosic material. In certain embodiments, the cellulosic material is wood, for example, and the polymeric material is polyethylene, for example. That said, any suitable cellulosic materials and/or polymeric materials can be used, such as synthetic polymers, for example. In at least one embodiment, the core comprises, by mass, between 50% and 70%, or more specifically between 55% and 65%, or more specifically approximately 60% wood, for example. In at least one embodiment, the core comprises, by mass, between 30% and 50%, or more specifically between 35% and 45%, or more specifically approximately 40% polyethylene, for example. In at least one embodiment, the core comprises, by mass, approximately 60% wood and approximately 60% polyethylene. The term “approximately” as used herein intends to include a tolerance of plus or minus 5%.

As noted above, the boards 20 may comprise a cap or shell layer that is extruded onto a surface of the core during an extrusion process to form a single structure for the board 20. The shell has a thickness between 0.5 mm and 5 mm, or between 0.5 mm and 3 mm in some embodiments, for example. The shell is formed from a polymeric material with additives for ultraviolet protection and scratch and/or mar performance, for example, but could be formed from any suitable material and may include any suitable additives, or no additives at all. The polymeric material is high density polyethylene in one embodiment, although other synthetic polymers may be used in other embodiments, for example. In some embodiments, the top, outwardly-facing, surface of the shell may comprise a textured feature, such as an embedded wood grain pattern, for example. The textured feature may comprise a debossed or embossed texture pattern on the top surface of the shell. In at least one embodiment, the textured feature comprises a debossed or embossed wood grain pattern, for example. In some embodiments, the shell may be omitted.

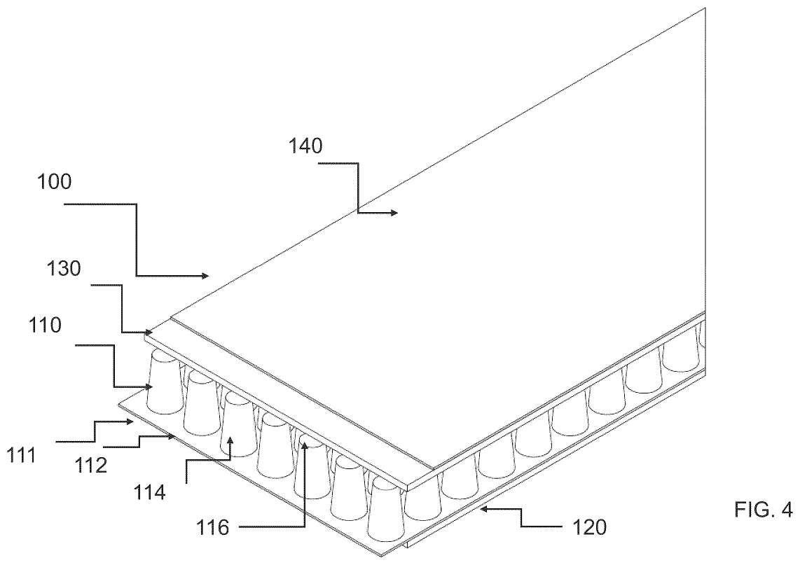

A manufactured composite board, or decking plank, 100 is illustrated in FIG. 4. The board 100 comprises a core 110, a first layer 120 attached to a first side of the core 110, a second layer 130 attached to a second side of the core 110, and an outer, or top, layer 140 attached to the second layer 130. The core 110 is comprised of a thermoplastic sheet including a core base 112 and dimples 114 formed in the core base 112. The core base 112 has a planar, or an at least substantially planar, first bonding surface 111 that is attached to the first layer 120. Each dimple 114 comprises a frustoconical shape, for example, having an open end defined in the core base 112 from the side of the first bonding surface 111 and a closed end 116 opposite the open end. Each closed end 116 defines a flat, or an at least substantially flat, surface that collectively form a second bonding surface that is attached to the second layer 130. The dimples 114, however, can have any suitable configuration.

In various instances, the thermoplastic sheet comprising the core 110 is comprised of high density polyethylene (HDPE), for example, but can be comprised of any suitable material. In at least one instance, the thermoplastic sheet comprises a filler material, such as fiberglass, for example, embedded in the high density polyethylene (HDPE) that strengthens the core 110. In addition to or in lieu of the above, the thermoplastic sheet comprises a cellulosic material, such as wood dust, or sawdust, for example, embedded in the high density polyethylene (HDPE). Similar to the fiberglass, the cellulosic material can strengthen the core 110. In various instances, the thermoplastic sheet is flat, or at least substantially flat, before it is shaped during a thermoforming process. In at least one such process, the flat thermoplastic sheet is heated into a flexible state, positioned over a mold, and then pushed downwardly onto the mold to create the dimples 114 in the core base 112. In at least one embodiment, the thermoplastic sheet is heated to its melt temperature, or a temperature slightly lower than its melt temperature, when the thermoplastic sheet is thermoformed. In at least one embodiment, the thermoplastic sheet is comprised of polyethylene and is heated to a temperature of at least 115 degrees Celsius, for example. Thereafter, the formed thermoplastic sheet cools sufficiently such that the formed thermoplastic sheet retains its formed shape. In at least one such process, the mold is actively cooled by a refrigeration circuit. Moreover, in at least one such process, a vacuum pump is used to create a pressure vacuum that pulls the heated thermoplastic sheet over the mold and holds the thermoplastic sheet in its formed shape as it cools.

As described above, the core 110 of the board 100 can be made from a sheet of thermoplastic material. In at least one manufacturing process, a pre-made sheet of thermoplastic material can be heated, pressed and/or held against the mold, cooled-or be permitted to cool, and then removed from the mold so that this process can be repeated again with another sheet of thermoplastic material in order to create another core 110.

As discussed above, referring again to FIG. 4, a first layer 120 is attached to a first bonding surface 111 of the core 110 and a second layer 130 is attached to a second bonding surface defined by the closed ends 116 of the dimples 114. The first layer 120 and the second layer 130 sandwich the core 110 and provide structural support to the core 110. The first layer 120 and the second layer 130 are comprised of a polymeric material, such as high density polyethylene (HDPE), for example, but can be comprised of any suitable material. In at least one instance, the first layer 120 and/or the second layer 130 comprise a polymeric substrate including a filler material, such as fiberglass, for example, embedded in the polymeric substrate. In addition to or in lieu of the above, the first layer 120 and/or the second layer 130 comprise a polymeric substrate and at least one cellulosic material, such as wood dust, or sawdust, for example, embedded in the polymeric substrate. The first layer 120 and the second layer 130 each comprise a flat, or an at least substantially flat, sheet of material, but can comprise any suitable configuration.

In various embodiments, further to the above, the first layer 120 and/or the second layer 130 are formed from a composite composition comprising a polymeric material and a cellulosic material. In certain embodiments, the cellulosic material is wood, for example, and the polymeric material is polyethylene, for example. That said, any suitable cellulosic materials and/or polymeric materials can be used, such as synthetic polymers, for example. In at least one embodiment, the first layer 120 and/or the second layer 130 comprise, by mass, between 50% and 70%, or more specifically between 55% and 65%, or more specifically approximately 60% wood, for example. In at least one embodiment, the first layer 120 and/or the second layer 130 comprise, by mass, between 30% and 50%, or more specifically between 35% and 45%, or more specifically approximately 40% polyethylene, for example. In at least one embodiment, the first layer 120 and/or the second layer 130 comprise, by mass, approximately 60% wood and approximately 60% polyethylene. The term “approximately” as used herein intends to include a tolerance of plus or minus 5%.

As discussed above, the first layer 120 is attached to the bonding surface 111 of the core 110. As also discussed above, the dimples 114 define openings in the bonding surface 111 and, as such, the first layer 120 is attached to the bonding surface 111 at locations between and/or around the dimple openings. As also discussed above, the second layer 130 is attached to the closed ends of the dimples 114 defined in the core 110 and, owing to this arrangement, portions of the second layer 130, i.e., the portions in between and around the dimples 114, are not attached to the core 110. As a result of this arrangement, voids are present between the first layer 120, the second layer 130, and the outside surfaces of the dimples 114. Voids are also defined between the first layer 120 and the inside surfaces of the dimples 114. Such voids can reduce the weight of the manufactured composite board 100 as compared to a solid manufactured composite board, or a manufactured composite board having a solid core, for example. In at least one embodiment, a manufactured composite board 100 with such an arrangement can be at least 80% lighter as compared to a solid manufactured composite board, for example.

In at least one manufacturing process, the first layer 120 and/or the core 110 are heated and then pressed together. In various embodiments, the first layer 120 and/or the core 110 are heated by hot air created by an air blower, for example. In at least one embodiment, the first layer 120 and/or the core 110 are heated when they pass over a hot plate and/or a hot roller, for example, that are heated by an electrical resistance circuit, for example. In various instances, one or more of the polymeric materials comprising the first layer 120 and the core 110 are heated to their melt temperature and then the first layer 120 is pressed against the bonding surface 111. In at least one embodiment, the first layer 120 and/or the core 110 are comprised of polyethylene and are heated to a temperature of at least 115 degrees Celsius, for example. As the first layer 120 and the core 110 cool, the first layer 120 becomes welded or laminated to the core 110. The second layer 130 is also heated and pressed against the core 110 at the same time that the first layer 120 is pressed against the core 110. In such instances, the first layer 120 and the second layer 130 become welded or laminated to opposite sides of the core 110 as the first layer 120, the second layer 130, and the core 110 cool. In various instances, one or more of the polymeric materials comprising the second layer 130 and the core 110 are heated to their melt temperature and then the second layer 130 is pressed against the core 110. In at least one embodiment, the second layer 130 and/or the core 110 are comprised of polyethylene and are heated to a temperature of at least 115 degrees Celsius, for example. The above being said, embodiments are envisioned in which the first layer 120 and the second layer 130 are sequentially welded or laminated to the core 110.

The top layer 140 of the board 100 is comprised of high density polyethylene (HDPE), for example, but can be comprised of any suitable material. In at least one instance, the top layer 140 comprises a polymeric substrate, such as high density polyethylene (HDPE), for example, and at least one filler material, such as fiberglass, for example, embedded in the high density polyethylene (HDPE). In addition to or in lieu of the above, the top layer 140 comprises a polymeric substrate including at least one cellulosic material, such as wood dust, or sawdust, for example, embedded in the polymeric substrate. The top layer 140 comprises a flat, or an at least substantially flat, sheet of material, but can comprise any suitable configuration. The entire disclosure of U.S. Pat. No. 10,773,500, entitled LAMINATED WOOD POLYMER COMPOSITE ARTICLE AND METHOD OF MAKING A LAMINATED WOOD POLYMER COMPOSITE ARTICLE, which issued on Sep. 15, 2020, is incorporated by reference herein.

In various embodiments, further to the above, the top layer 140 is formed from a composite composition comprising a polymeric material and a cellulosic material. In certain embodiments, the cellulosic material is wood, for example, and the polymeric material is polyethylene, for example. That said, any suitable cellulosic materials and/or polymeric materials can be used, such as synthetic polymers, for example. In at least one embodiment, the top layer 140 comprises, by mass, between 50% and 70%, or more specifically between 55% and 65%, or more specifically approximately 60% wood, for example. In at least one embodiment, the top layer 140 comprises, by mass, between 30% and 50%, or more specifically between 35% and 45%, or more specifically approximately 40% polyethylene, for example. In at least one embodiment, top layer 140 comprises, by mass, approximately 60% wood and approximately 60% polyethylene. The term “approximately” as used herein intends to include a tolerance of plus or minus 5%.

In at least one manufacturing process, the top layer 140 and/or the composite comprising the first layer 120, the core 110, and the second layer 130 are heated and then pressed together. In various embodiments, the top layer 140 and/or the composite are heated by hot air created by an air blower, for example. In at least one embodiment, the top layer 140 and/or the composite are heated when they pass over a hot plate and/or a hot roller, for example, that are heated by an electrical resistance circuit, for example. In various instances, one or more of the polymeric materials comprising the top layer 140 and the second layer 130 are heated to their melt temperature and then the top layer 140 is pressed against the second layer 130. In at least one embodiment, the top layer 140 and/or the second layer 130 are comprised of polyethylene and are heated to a temperature of at least 115 degrees Celsius, for example. As the top layer 140 and the second layer 130 cool, the top layer 140 becomes welded or laminated to the second layer 130.

As discussed above, the core 110, the first layer 120, the second layer 130, and the top layer 140 are thermally bonded to form a composite. In addition to or in lieu of thermally bonding these layers, at least one adhesive can be used to bond the first layer 120 to the core 110, the second layer 130 to the core 110, and/or the top layer 140 to the second layer 130. In at least one such embodiment, the adhesive comprises polyurethane, for example.

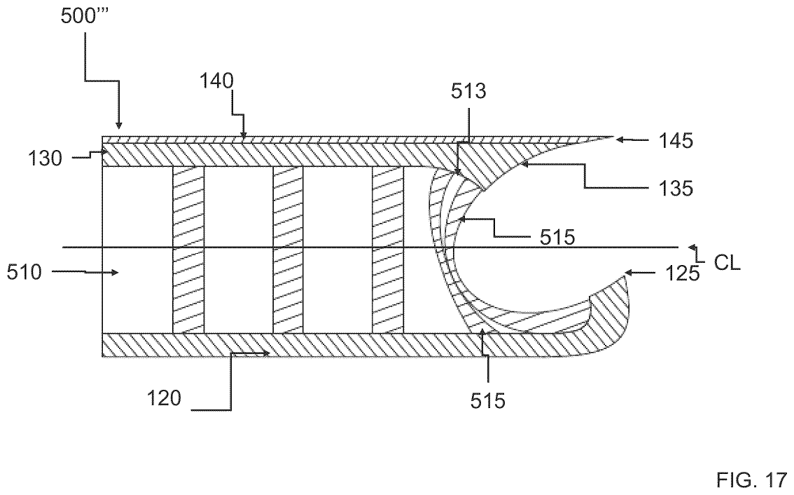

In various embodiments, referring to FIG. 18A, a manufacturing process can be used to create core sheets 1510, for example, that are each used to create a plurality of decking planks. The core sheets 1510 can, in various embodiments, produce cores 110, described above, or any of the cores disclosed herein. Referring to FIG. 18B, the core sheets 1510 can be made during a continuous, or an at least nearly continuous, manufacturing process, such as manufacturing process 2500, for example. The manufacturing process 2500 comprises an extruder 2510 that supplies a continuous thermoplastic sheet 1510″ to a press having rollers 2520. In various instances, the continuous thermoplastic sheet 1510″ is supplied to the press in a heated flexible state such that, as the thermoplastic sheet 1510″ passes between the rollers 2520, dimples, such as dimples 114, for example, are thermoformed into the thermoplastic sheet 1510″ to create a continuous core sheet 1510′. In various embodiments, the press of the manufacturing process 2500 heats the continuous thermoplastic sheet 1510″ before the dimples are thermoformed into the thermoplastic sheet 1510″ and/or as the dimples are thermoformed into the thermoplastic sheet 1510″. In at least one embodiment, the thermoplastic sheet 1510″ is heated by a convection system that blows hot air onto the thermoplastic sheet 1510″. As the continuous core sheet 1510′ is created, the continuous core sheet 1510′ can be fed into a subsequent step in the manufacturing process 2500 or cut into individual core sheets 1510, as seen in FIG. 18C. In either event, layers can be attached to the continuous core sheet 1510′ and/or the individual core sheets 1510 to create a composite material that is cut longitudinally along lines 1505 to create decking planks. As described above, the manufacturing process 2500 is continuous in that the thermoplastic sheet 1510″ is fed directly into the press to create the continuous core sheet 1510′ and produce a continuous stream of material until the manufacturing process 2500 needs to be interrupted to re-supply the extruder 2510 with thermoplastic material, for example.

As discussed above, the manufacturing process 2500 can be used to create a core of a decking plank. As also discussed above, the manufacturing process 2500 is, in various embodiments, configured to create dimples in a thermoplastic material to create the core. Further to the below, the manufacturing process 2500 is, in various embodiments, configured to create a core from folded material.

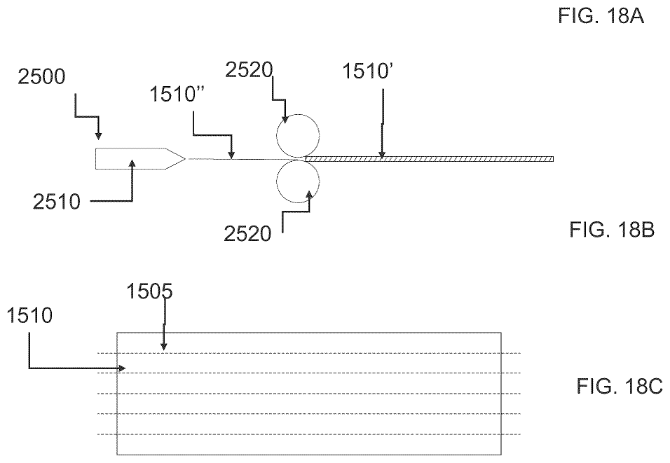

Referring to FIG. 19A, at least one manufacturing process, such as manufacturing process 3500, for example, incorporates the manufacturing process 2500 described above to create a continuous core sheet 1510′. The manufacturing process 3500 further comprises an extruder 3520 that creates a continuous first thermoplastic layer 1520 that is wound around a spool 3620 for a later step in the manufacturing process 3500. The manufacturing process 3500 further comprises a second extruder that creates a continuous second thermoplastic layer 1530 that is wound around a spool 3630 for a later step in the manufacturing process 3500. In various embodiments, the first thermoplastic layer 1520 can be used to create first layers 120 and the second thermoplastic layer 1530 can be used to create second layers 130, for example. In various instances, the second layer 1530 is different than the first layer 1520. In at least one embodiment, for instance, the first layer 1520 has a different thickness than the second layer 1530. In at least one such embodiment, the second layer 1530 constitutes an upper wear surface and is thicker than the first layer 1520. In at least one embodiment, the first layer 1520 is comprised of a different material than the second layer 1530. In at least one embodiment, for instance, the second layer 1530 constitutes an upper surface and is comprised of thermoplastic with wood embedded therein whereas the first layer 1520 is comprised of thermoplastic without wood embedded therein. Other embodiments, however, are envisioned in which the first layer 1520 and the second layer 1530 are comprised of the same material and have the same thickness.

Referring again to FIG. 19A, the continuous core sheet 1510′, the continuous first layer 1520, and the continuous second layer 1530 are fed into a press of the manufacturing process 3500 that comprises rollers 3720 and 3730. The continuous first layer 1520 is fed into the press on a first side of the continuous core sheet 1510′ and the continuous second layer 1530 is fed into the press on a second, or opposite, side of the continuous core sheet 1510′. The continuous first layer 1520, the continuous core sheet 1510′, and the continuous second layer 1530 are pulled into the press by the rollers 3720 and 3730 and pressed between the rollers 3720 and 3730 to create a continuous composite sheet 1500′. The continuous core sheet 1510′, the first continuous layer 1520, and/or the second continuous layer 1530 are supplied to the press in a heated flexible state such that the continuous layers 1520 and 1530 are thermally bonded to the continuous core sheet 1510′. The rollers 3720 and 3730 of the press are also heated to facilitate the thermal bonding of the continuous layers 1520 and 1530 to the continuous core sheet 1510′. In at least one such embodiment, each roller 3720, 3730 comprises an electrical resistance circuit that heats the surfaces of the rollers 3720, 3730, for example. As the continuous composite sheet 1500′ is created, the continuous composite sheet 1500′ can be fed into a subsequent step in the manufacturing process 3500 or cut into individual composite sheets.

A manufacturing process 3500′ illustrated in FIG. 19B is similar to the manufacturing process 3500 in many respects. For instance, the manufacturing process 3500′ comprises a press including rollers 3720 and 3730 and a continuous core sheet 1510′ that is fed into the press. The manufacturing process 3500′, however, does not have a spool 3620 that feeds a continuous first layer 1520 into the press or a spool 3630 that feeds a continuous second layer 1530 into the press. Instead, the manufacturing process 3500′ comprises a first extruder 3520 that feeds a continuous first layer 1520 directly into the press and a second extruder 3530 that feeds a continuous second layer 1530 directly into the press. The first layer 1520 exits the first extruder 3520 in a heated flexible state such that the first layer 1520 can be welded to the continuous core sheet 1510′ in the press to form the continuous composite sheet 1500′. Similarly, the second layer 1530 exits the second extruder 3530 in a heated flexible state such that the second layer 1530 can also be welded to the continuous core sheet 1510′ in the press to form the continuous composite sheet 1500′. As the continuous composite sheet 1500′ is created, similar to the above, the continuous composite sheet 1500′ can be fed into a subsequent step in the manufacturing process 3500′ or cut into individual composite sheets.

A manufacturing process 3500″ illustrated in FIG. 19C is similar to the manufacturing processes 3500 and 3500′ in some respects. For instance, the manufacturing process 3500″ comprises a continuous feed of core sheet 1510′ that is used to create a continuous composite sheet 1500′. The manufacturing process 3500″ further comprises a first extruder 3820 that co-extrudes a first thermoplastic layer 1520 directly onto the continuous core sheet 1510′ and a second extruder 3830 that co-extrudes a second thermoplastic layer 1530 directly onto the continuous core sheet 1510′. The first extruder 3820 deposits a first thermoplastic material onto the continuous core sheet 1510′ in a fluidic state to create the first thermoplastic layer 1520. The first thermoplastic material can be comprised of one type of polymer or several types of polymers. In at least one instance, the first extruder 3820 can heat at least one of the polymers of the first thermoplastic material to or above its melt temperature to make the first thermoplastic material fluidic. Similarly, the second extruder 3830 deposits a second thermoplastic material onto the continuous core sheet 1510′ in a fluidic state to create the second thermoplastic layer 1530. The second thermoplastic material can be comprised of one type of polymer or several types of polymers. In at least one instance, the second extruder 3830 can heat at least one of the polymers of the second thermoplastic material to or above its melt temperature to make the second thermoplastic material fluidic. As the first and second thermoplastic materials cool, the first and second thermoplastic layers 1520, 1530 become thermally bonded to the continuous core sheet 1510′ to form a continuous composite sheet 1500′. As the continuous composite sheet 1500′ is created, the continuous composite sheet 1500′ can be fed into a subsequent step in the manufacturing process 3500″ or cut into individual composite sheets.

In various instances, further to the above, a layer can become mechanically interconnected and/or interlocked with the core and/or another layer of a composite as the layer cools. In some such instances, the configuration of a heated layer can adapt to the configuration of an adjacent layer and/or core to create a mechanical bond therebetween.

In various embodiments, a composite sheet 1500′ comprising the core sheet 1510′, the first layer 1520, and the second layer 1530 is suitable to be slit longitudinally, referring again to FIG. 18C, to create a plurality of rectangular decking planks, or boards, such as board 100, for example, and/or any of the boards described herein. In such embodiments, the manufacturing process 3500 comprises a slitting machine having a plurality of cutting edges, or knives, that cut the composite sheet. After a board has been cut to a suitable width and length, one of the first layer 1520 or the second layer 1530 will comprise the top surface of the board while the other one will comprise the bottom surface of the board facing the support structures 50 of the deck. The layer on the top side of the board can have an embedded decorative design that mimics wood grain, for example. The layer on the top side of the board can also have one or more additives embedded in its thermoplastic material that resists wear, for example. In addition to or in lieu of this arrangement, as discussed further below, the board can have an additional layer that provides a decorative and/or wear-resistant layer. For instance, referring again to FIG. 4, the board 100 comprises a top thermoplastic layer 140 attached to the second layer 130 that provides an aesthetic effect and is wear-resistant, for example.

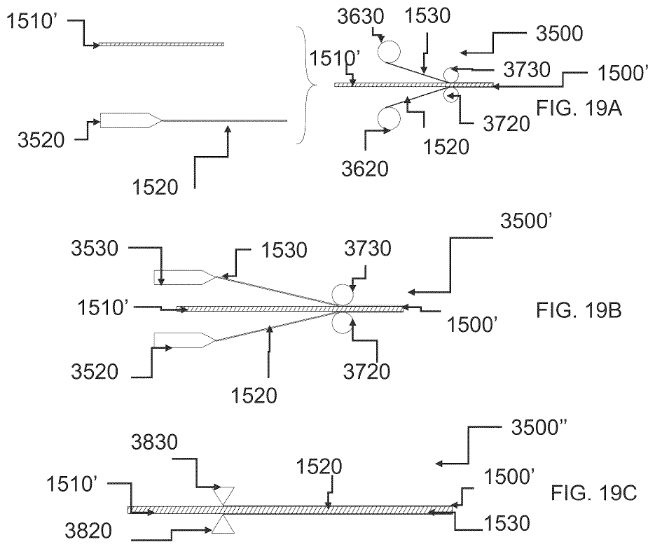

Referring to FIG. 20A, a manufacturing process, such as manufacturing process 4500, for example, incorporates at least one of the manufacturing processes 3500, 3500′, and 3500″ described above to create a composite sheet 1500′, as discussed above. The manufacturing process 4500 further comprises an extruder 4540 that creates a top thermoplastic layer 1540 that is attached to the second layer 1530 of a composite sheet 1500′. In various instances, individually-cut sheets of the top layer 1540 are created and attached to individually-cut sheets of the composite sheet 1500′. In such instances, a sheet of top layer 1540 and/or a sheet of composite sheet 1500′ are heated and then pressed together such that, when the top layer 1540 and the composite sheet 1500′ cool, the top layer 1540 is thermally bonded to the composite sheet 1500′ to form a final composite sheet 1500. In various embodiments, further to the above, the individually-cut composite sheets 1500′ and the individually-cut sheets of top layer 1540 are cut to the same size, or at least substantially the same size, such that, when a sheet of top layer 1540 is aligned with a composite sheet 1500′ to create a final composite sheet 1500, the edges of the top layer 1540 are aligned with, or at least substantially aligned with, the edges of the composite sheet 1500′.

In various instances, referring again to FIG. 20A, the manufacturing process 4500 is configured to create a continuous final composite sheet 1500 that is then cut into individual final composite sheets 1500. As illustrated in FIG. 20A, a continuous top layer 1540 can be created by an extruder 4540 and wrapped around a spool 4640. In various instances, the continuous composite sheet 1500′ and the continuous top layer 1540, as it is unwrapped from the spool 4640, are fed into the press in a flexible heated state such that, when the continuous composite sheet 1500′ and the continuous top layer 1540 are pressed together, the continuous top layer 1540 is thermally bonded to the continuous composite sheet 1500′ to form a continuous final composite sheet 1500 when the top layer 1540 and the continuous composite sheet 1500′ cool. As the continuous final composite sheet 1500 is created, final composite sheets 1500 can be slit longitudinally, referring again to FIG. 18C, to create a plurality of rectangular decking planks, or boards, such as boards 100, for example, and/or any of the boards described herein. In such embodiments, the manufacturing process 4500 comprises a slitting machine having a plurality of cutting edges, or knives, that cut the final composite sheet 1500.

A manufacturing process 4500′ illustrated in FIG. 20B is similar to the manufacturing process 4500 in many respects. For instance, the manufacturing process 4500′ comprises a press including at least one roller 4740 and a continuous composite sheet 1500′ that is fed into the press. The manufacturing process 4500′, however, comprises an extruder 4540 that feeds a continuous top layer 1540 directly into the press. The continuous top layer 1540 exits the first extruder 4540 in a heated flexible state such that the top layer 1540 can be thermally bonded to the continuous composite sheet 1500′ in the press to form the continuous final composite sheet 1500. As the continuous final composite sheet 1500 is created, similar to the above, the continuous final composite sheet 1500 can be cut into individual final composite sheets 1500. At such point, the final composite sheets 1500 can be slit longitudinally, referring again to FIG. 18C, to create a plurality of rectangular decking planks, or boards, such as boards 100, for example, and/or any of the boards described herein. In such embodiments, the manufacturing process 4500 comprises a slitting machine having a plurality of cutting edges, or knives, that cut the final composite sheet 1500.

A manufacturing process 4500″ illustrated in FIG. 20C is similar to the manufacturing processes 4500 and 4500′ in some respects. For instance, the manufacturing process 4500″ comprises a continuous composite sheet 1500′ that is supplied to create a continuous final composite sheet 1500. The manufacturing process 4500″ further comprises an extruder 4840 that co-extrudes a top layer 1540 directly onto the continuous composite sheet 1500′. The extruder 4840 deposits a thermoplastic material onto the continuous composite sheet 1500′ in a fluidic state to create the top layer 1540. The thermoplastic material can be comprised of one type of polymer or several types of polymers. In at least one instance, the extruder 4840 can heat at least one of the polymers of the thermoplastic material to or above its melt temperature to make the thermoplastic material fluidic. As the thermoplastic material cools, the top layer 1540 becomes welded to the continuous composite sheet 1500′ to form a continuous final composite sheet 1500. As the continuous final composite sheet 1500 is created, the continuous final composite sheet 1500 can be cut into individual composite sheets. At such point, the final composite sheet 1500 can be slit longitudinally, referring again to FIG. 18C, to create a plurality of rectangular decking planks, or boards, such as boards 100, for example, and/or any of the boards described herein. In such embodiments, the manufacturing process 4500 comprises a slitting machine having a plurality of cutting edges, or knives, that cut the final composite sheet 1500.

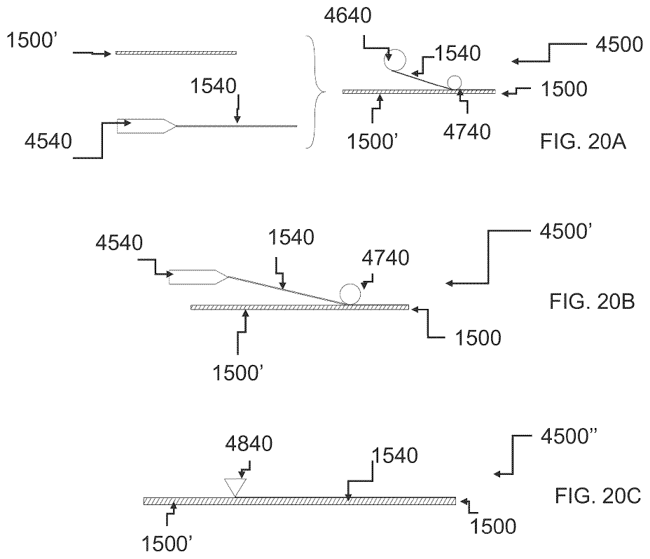

As described above, the manufacturing process 2500 is used to create an inner core 1510 of the final composite sheet 1500, the manufacturing process 3500 adds the first and second layers 1520, 1530, and the manufacturing process 4500 adds the top layer 1540. As also described above, the manufacturing processes 3500′, 3500″, or any other suitable manufacturing process, can be used in lieu of the manufacturing process 3500 and/or the manufacturing processes 4500′, 4500″, or any other suitable manufacturing process, can be used in lieu of the manufacturing process 4500. As also described above, various steps of the manufacturing processes 2500, 3500, and 4500, for example, can be performed at the same time, consecutively, and/or at different times to produce a final composite sheet 1500 or decking planks, or boards, cut from a final composite sheet 1500. Referring to FIG. 21, a manufacturing process, such as manufacturing process 5500, for example, produces a continuous final composite sheet 1500 from a core layer produced by an extruder 2510, a first layer 1520 produced by an extruder 3520, a second layer 3530 produced by an extruder 3530, and a top layer 1540 produced by an extruder 4840. The manufacturing process 5500 further comprises a press including rollers 2520 that, in various embodiments, thermoform the core layer and a press including rollers 3720 and 3730 that connects the first layer 1520 and the second layer 1530 to the core layer. In various embodiments, further to the below, the manufacturing process 5500 comprises one or more folding stations that can create the core layer. Similar to the above, the final composite sheet 1500 can be slit longitudinally to create a plurality of rectangular decking planks, or boards, such as boards 100, for example, and/or any of the boards described herein. To achieve this, in at least one embodiment, the manufacturing process 5500 comprises a slitting machine having a plurality of cutting edges, or knives, that cut the final composite sheet 1500. In at least one embodiment, the slitting machine is positioned at the end of the manufacturing process 5500.

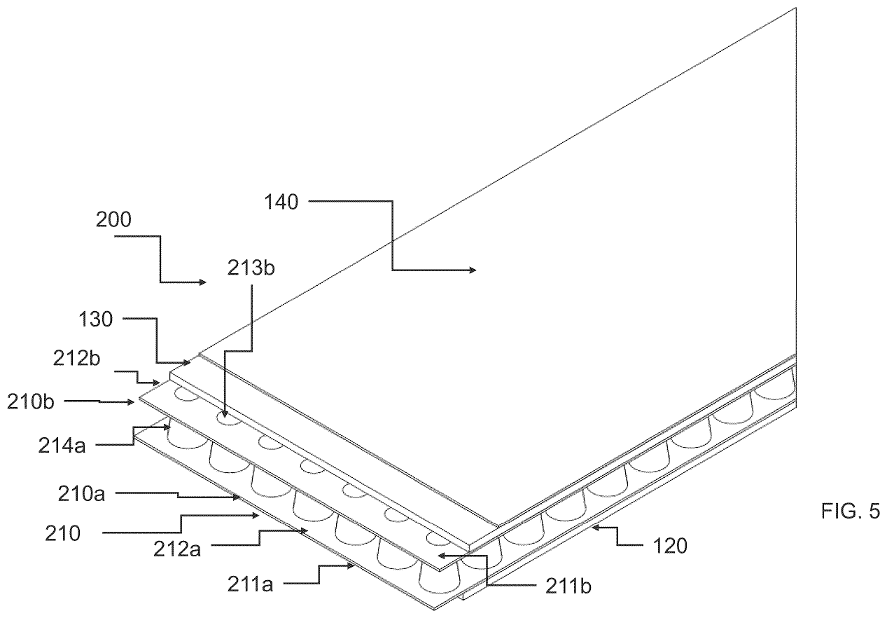

A manufactured composite board, or decking plank, 200 is illustrated in FIG. 5. The board 200 comprises a core 210, a first layer 120 attached to a first side of the core 210, a second layer 130 attached to a second side of the core 210, and an outer, or top, layer 140 attached to the second layer 130. The core 210 is comprised of two thermoplastic sheets, i.e., a first core sheet 210a and a second core sheet 210b, bonded to one another. The first core sheet 210a comprises a core base 212a and dimples 214a formed in the core base 212a. The core base 212a has a planar, or an at least substantially planar, first bonding surface 211a that is attached to the first layer 120. Each dimple 214a comprises a frustoconical shape, for example, having an open end defined in the core base 212a from the side of the first bonding surface 211a and a closed end opposite the open end. Each closed end defines a flat, or an at least substantially flat, surface that collectively form an intermediate bonding surface that is attached to the second core sheet 210b. The second core sheet 210b comprises a core base 212b and dimples formed in the core base 212b. The core base 212b has a planar, or an at least substantially planar, first bonding surface 211b that is attached to the second layer 130. The dimples of the second core sheet 210b are similar to the dimples of the first core sheet 210a and comprise a frustoconical shape, for example, having an open end 213b defined in the core base 212b from the side of the first bonding surface 211b and a closed end opposite the open end 213b. Each closed end defines a flat, or an at least substantially flat, surface that collectively form an intermediate bonding surface that is attached to the first core sheet 210a. More specifically, the dimples 214a of the first core sheet 210a are aligned, at least substantially aligned, with the dimples of the second core sheet 210b such that the closed ends of the dimples can be attached to one another. In various embodiments, the closed ends of the dimples on the core sheets 210a, 210b are heated, pressed together, and then cooled, or permitted to cool, such that the core sheets 210a, 210b are thermally bonded or welded to one another. In at least one embodiment, the core sheets 210a, 210b are bonded to one another by one or more adhesives, such as urethane, for example.

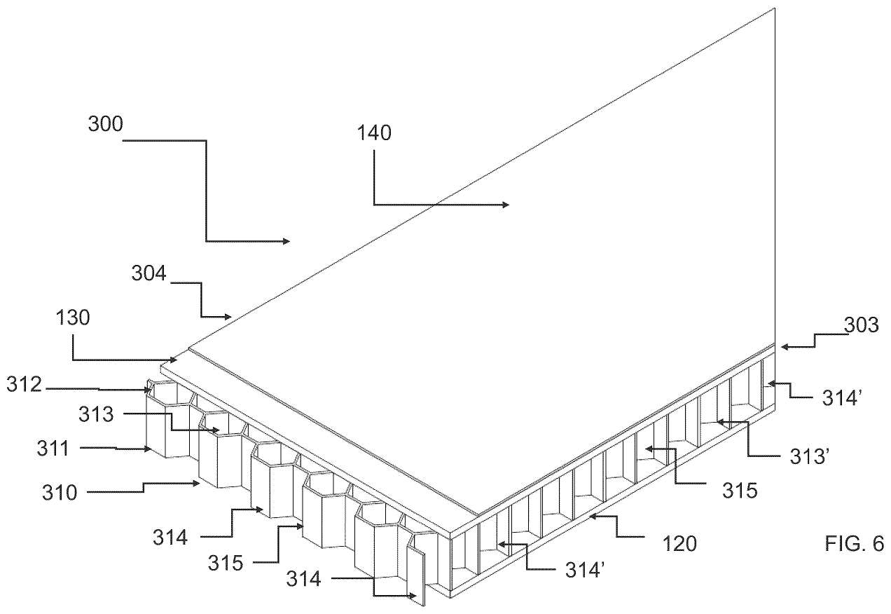

A manufactured composite board, or decking plank, 300 is illustrated in FIG. 6. The board 300 comprises a core 310, a first layer 120 attached to a first side 311 of the core 310, a second layer 130 attached to a second side 312 of the core 310, and an outer layer 140 attached to the second layer 130. In at least one manufacturing process, the core 310, the first layer 120, and the second layer 130 are heated and pressed together to thermally bond or weld the layers 120, 130 to the core 310. In at least one such manufacturing process, the first side 311 and the second side 312 of the core 310 are heated with opposing heated plates and/or rollers before the first and second layers 120, 130 are pressed against the first and second sides 311, 312, respectively. Similar to the above, in various embodiments, the first and second layers 120, 130 are heated before they are pressed against the core 310. That said, any of the manufacturing processes disclosed herein, and/or any other suitable manufacturing process, can be used to create the board 300. For instance, the manufacturing process 3500 (FIG. 19A) can be used to attach the first and second layers 120, 130 to the core 310 and the manufacturing process 4500 (FIG. 20A) can be used to attach the top layer 140 to the second layer 130.

The core 310 comprises a honeycomb configuration including a plurality of hexagonal cells 314. Each cell 314 has an opening, or through hole, 313 extending from the first side 311 of the core 310 to the second side 312 of the core 310 that is defined by walls 315. The walls 315 of the core 310 are comprised of one or more thermoplastic materials, for example, but can be comprised of any suitable material. In at least one instance, the walls 315 comprise a polymeric substrate, such as high density polyethylene (HDPE), for example, and at least one filler material, such as fiberglass, for example, embedded in the polymeric substrate. In at least one instance, the walls 315 comprise a polymeric substrate, such as high density polyethylene (HDPE), for example, including at least one cellulosic material, such as wood dust, or sawdust, for example, embedded in the polymeric substrate. The core 310 can be made by any suitable manufacturing process. In at least one manufacturing process, the core 310 is made from an extrusion process in which heated thermoplastic material is pushed through an extrusion die to create a honeycomb block. The honeycomb block is then cut to make one or more cores 310 having a suitable thickness between the first side 311 and the second side 312. Individually-cut layers 120, 130 can then be attached to the cores 310 and an individually-cut layer 140 can be attached to the second layers 130.

In at least one manufacturing process, further to the above, a continuous honeycomb core layer is produced in a manufacturing process similar to the manufacturing process 2500, for example, and continuous layers 120, 130 are attached to the continuous honeycomb core layer by a manufacturing process 3500, for example. A manufacturing process 4500, for example, can then be used to attach a continuous layer 140 to the second layer 130. At such point, the continuous layer can be cut into panels and the panels can be slit into boards by one or more cutting machines.

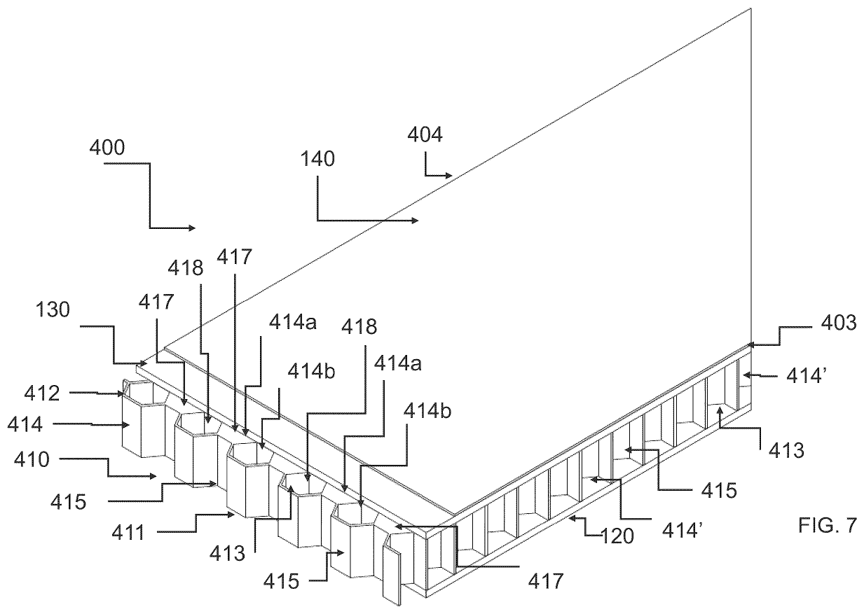

A board 400 is illustrated in FIG. 7 that comprises a honeycomb core 410 created from a continuous folding process. The board 400 comprises a first layer 120 attached to a first side 411 of the core 410, a second layer 130 attached to a second side 412 of the core 410, and an outer layer 140 attached to the second layer 130. In at least one manufacturing process, the core 410, the first layer 120, and the second layer 130 are heated and pressed together to thermally bond or weld the layers 120, 130 to the core 410. In at least one such manufacturing process, the first side 411 and the second side 412 of the core 410 are heated with opposing heated plates and/or heated rollers before the first and second layers 120, 130 are pressed against the first and second sides 411, 412, respectively. Similar to the above, in various embodiments, the first and second layers 120, 130 are heated before they are pressed against the core 410. That said, any of the manufacturing processes disclosed herein, and/or any other suitable manufacturing process, can be used to create the board 400. For instance, the manufacturing process 3500 (FIG. 19A) can be used to attach the first and second layers 120, 130 to the core 410 and the manufacturing process 4500 (FIG. 20A) can be used to attach the top layer 140 to the second layer 130.

In various embodiments, a sheet comprised of at least one thermoplastic material is cut and/or folded into shape to create the honeycomb configuration of the core 410 which includes a plurality of hexagonal cells 414. Each cell 414 is defined by side walls 415 and has an opening 413 on one side of the core 410 and a closed end 417 on the opposite side of the core 410. The closed ends 417 on one side of the core 410 at least partially form the first side 411 of the core 410 and the closed ends 417 on the other side of the core 410 at least partially form the second side 412. In various embodiments, the sheet used to form the core 410 has a polymeric substrate, such as high density polyethylene (HDPE), for example, and at least one filler material, such as fiberglass, for example, embedded in the polymeric substrate. In at least one embodiment, the sheet has a polymeric substrate, such as high density polyethylene (HDPE), for example, and at least one cellulosic material, such as wood dust, or sawdust, for example, embedded in the polymeric substrate. In various embodiments, the polymeric substrate comprises both fiberglass and wood embedded in the substrate.

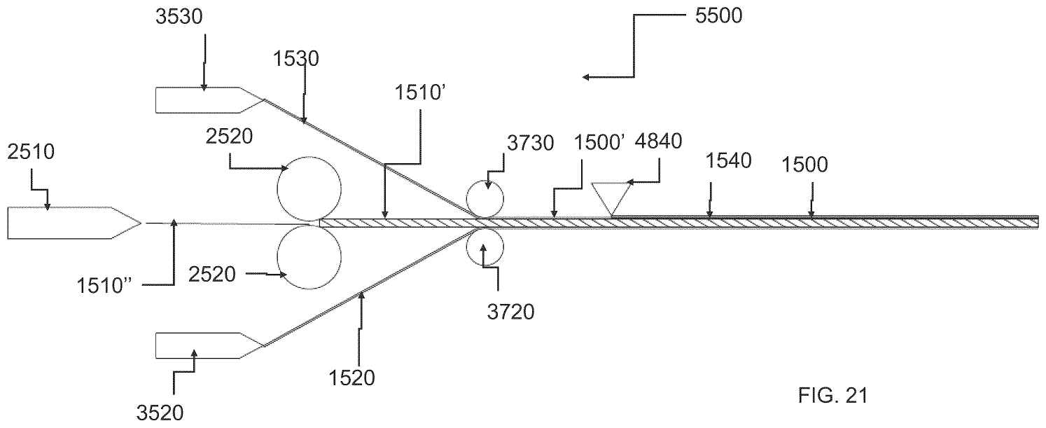

As described above, a sheet of material is cut and/or folded into shape to create the honeycomb core 410 during a manufacturing process. Referring to FIG. 22, the core 410 is produced from folded material 410′ that comprises opposing walls 415a′ and 415b′ and side walls 415c′. The opposing walls 415a′ and 415b′ are hingedly connected together about hinges 419a′ and 419b′ such that, when the folded material 410′ is folded into its fully-folded configuration along machine direction MD to form the core 410, the opposing walls 415a′ and 415b′ come into contact with one another. Notably, the walls 415a′ are defined on half-hexagonal cells 414a′ and the walls 415b′ are defined on half-hexagonal cells 414b′ that come together to form the cells 414 of the core 410 when the opposing walls 415a′ and 415b′ are brought into contact with one another. At such point, the walls 415a′ and 415b′ are bonded together by thermal bonding and/or one or more adhesives, for example. As a result of the above, each cell 414 of the core 410 is defined by a wall 415a′, a wall 415b′, and four side walls 415c′. Moreover, each half-hexagonal cell 414a′ and 414b′ is further defined by a partial closed end 417′ that come together to form the closed ends 417 of the cells 414. Notably, the partial closed ends 417′ are hingedly connected together about the hinges 419b′ of the folded material 410′. Similarly, the half-hexagonal cells 414a′ and 414b′ are hingedly connected together about the hinges 419a′ by connectors 418′ that at least partially define the open ends 418 of the cells 414 when the folded material 410′ is folded into its fully-folded configuration.

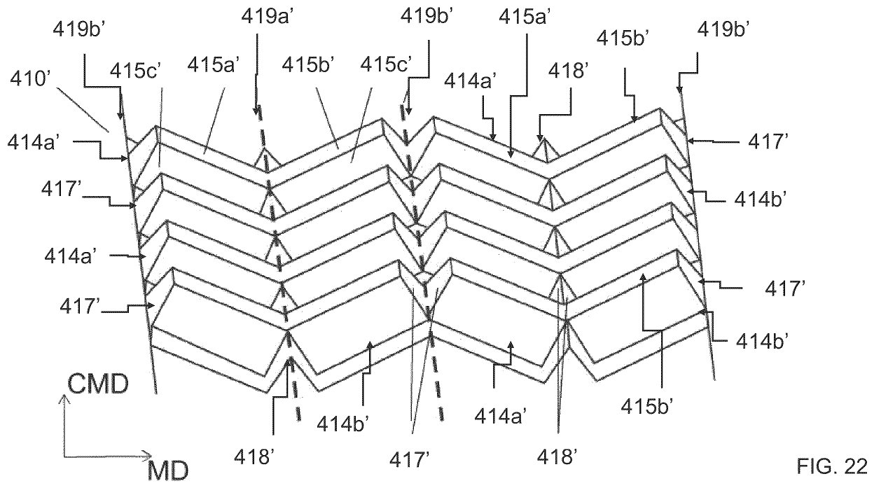

Further to the above, FIG. 23 depicts a folding unit comprising, among other things, feeding rollers 20, a guiding grid 11 downstream of the feeding rollers 20, and pushing rollers 22 downstream of the guiding grid 11 that can create a fully-folded core, such as core 410, for example. The feeding rollers 20 comprise rubber-coated feeding rollers 10, for example, with grooves 10a defined therein that are configured to receive material that has already been partially folded, such as the material 410′ illustrated in FIG. 22, for example. The guiding grid 11 receives the material from the feeding rollers 20 and includes guides 11a that keep the material in a workflow plane between the feeding rollers 20 and the pushing rollers 22. The pushing rollers 22 comprise rubber-coated rollers 12 with grooves 12a defined therein that apply a counter pressure to the material. Stated another way, the pushing rollers 22 apply a sufficient in-plane compression force to the material which assists in folding the material into a fully-folded, stacked configuration. A gating, or braking, mechanism 13 retards the flow of the material and opens at a force that is transmitted through the material only when the material is in a fully-folded state. Even when the gating mechanism 14 is in an open state, it continues to apply a friction force to the material as the material passes therethrough. At such point, covering layers are applied to the fully-folded core by lamination and/or direct extrusion onto both sides of the core via lamination rollers or belts 23, for example. The folding unit of FIG. 23 can further comprise one or more gluing and/or thermal welding units that bond the folded material together and bond the covering layers to the core.

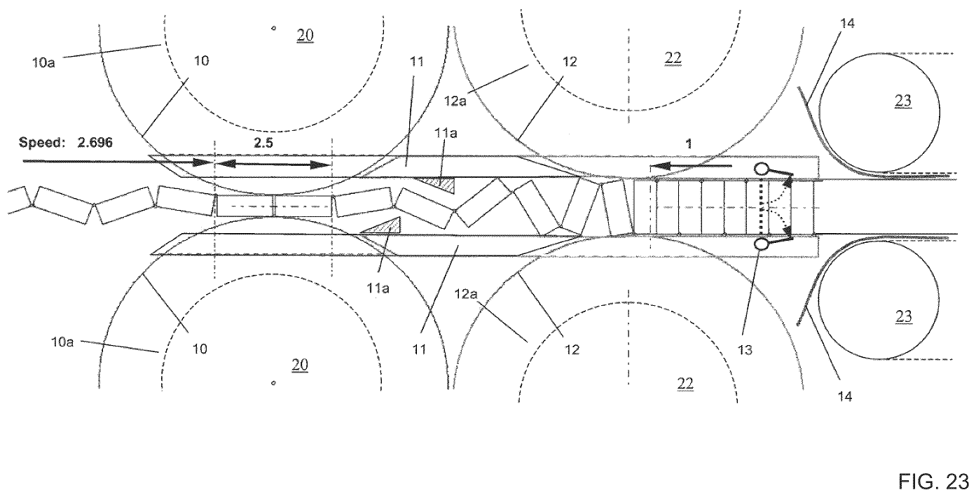

Further to the above, a process flow diagram of a method 6000 is depicted in FIG. 24. The method 6000 comprises steps for creating a manufactured composite decking plank, or board, such as the manufactured composite boards disclosed herein, for example. The method 6000 comprises a step 6100 that includes extruding a layer and/or feeding a layer from a roll. In various versions of this embodiment, the layer is extruded and directly fed into a folding unit, such as the folding unit illustrated in FIG. 23, for example. In other versions of this embodiment, the layer is extruded and then wound into a roll which is later used to feed the layer into a folding unit. In either event, after step 6100, the layer is folded into a three-dimensional structure at step 6200. Such a three-dimensional structure can comprise core 410, for example. One or more layers are then laminated to the three-dimensional structure at step 6300 to form a composite. Such layers can comprise layers 120, 130, and/or 140, for example. Thereafter, the composite is cut to create decking planks, or boards, such as boards 400, for example, at step 6400. The method 6000 can include one or more additional steps before step 6100, one or more additional steps between step 6100 and step 6200, one or more steps between step 6200 and step 6300, one or more steps between step 6300 and step 6400, and/or one or more steps after step 6400.

Referring again to FIG. 18A, the core sheet 1510 can have a folded honeycomb configuration. Referring again to FIG. 18B, the extruder 2510 of the manufacturing process 2500 can create a thermoplastic sheet 1510″ that is folded in a folding unit that includes rollers 2520, for example, to make a continuous folded honeycomb core sheet 1510′. Referring again to FIGS. 19A and 19B, the continuous folded honeycomb core sheet 1510′ can be fed into a press during the manufacturing process 3500 and/or 3500′ to have layers 1520 and 1530 laminated thereto to form a continuous composite sheet 1500′ having a folded honeycomb core. In addition to or in lieu of the manufacturing processes 3500 and 3500′, the continuous folded honeycomb core sheet 1510′ can receive one or more layers via a direct extrusion process, such as process 3500″ illustrated in FIG. 19C, for example, to form the continuous composite sheet 1500′. Similarly, any one of the processes illustrated in FIGS. 20A, 20B, and 20C can be used to laminate a layer, such as layer 1540, for example, to the continuous folded honeycomb core sheet 1510′ to produce a final composite sheet 1500 having a folded honeycomb core configuration. Moreover, referring again to FIG. 21, the continuous core sheet 1510′ created during the manufacturing process 5500 can have a folded honeycomb core configuration to create a final composite sheet 1500 having a folded honeycomb core configuration.

Further to the above, the folded honeycomb core configuration discussed above can reduce the weight of a manufactured composite board as compared to a solid manufactured composite board, or a manufactured composite board having a solid core, for example. In at least one embodiment, a manufactured composite board with such a folded honeycomb core arrangement can be at least 80% lighter as compared to a solid manufactured composite board, for example.

The entire disclosures of U.S. Pat. No. 8,795,806, entitled HALF CLOSED THERMOPLASTIC HONEYCOMB, THEIR PRODUCTION PROCESS AND EQUIPMENT TO PRODUCE, which issued on Aug. 5, 2014, U.S. Pat. No. 11,267,212, entitled HONEYCOMB CORE WITH HIERARCHIAL CELLULAR STRUCTURE, which issued on Mar. 8, 2022, U.S. Patent Application Publication No. 2021/0268763, entitled FOLDED CORE STRUCTURE AND PROCESS FOR PROVIDING A FOLDED CORE STRUCTURE, which published on Sep. 2, 2021, U.S. Pat. No. 11,421,428, entitled FLOATING FLOOR SYSTEM, which issued on Aug. 23, 2022, U.S. Patent Application Publication No. 2021/0362461, entitled THREE-DIMENSIONAL THERMOPLASTIC SANDWICH PANEL COMPOSITE, which published on Nov. 25, 2021, U.S. Patent Application Publication No. 2022/0314577, entitled UNDERLAYMENT, which published on Oct. 6, 2022, U.S. Pat. No. 11,192,316, entitled HIERARCHIAL HONEYCOMB CORE WITH SANDWICH CELL WALLS, which issued on Dec. 7, 2021, International Patent Application Publication No. WO 2021/122195 A1, entitled FLOORING COMPOSITE, which published on Jun. 24, 2021, International Patent Application Publication No. WO 2023/217688 A1, entitled THERMOPLASTIC HONEYCOMB WITH IMPROVED CELL WALLS, PRODUCTION PROCESS, AND EQUIPMENT, which published on Nov. 16, 2023, International Patent Application Publication No. WO 2023/227542 A1, entitled THERMOPLASTIC HONEYCOMB STRUCTURES WITH MULTI-LAYER CELL WALLS, THEIR PRODUCTION PROCESS AND EQUIPMENT, which published on Nov. 30, 2023, International Patent Application Publication No. WO 2006/053407 A1, entitled HALF CLOSED THERMOPLASTIC HONEYCOMB, THEIR PRODUCTION PROCESS AND EQUIPMENT TO PRODUCE, which published on May 26, 2006, and International Patent Application Publication No. WO 2024/008637 A1, entitled SANDWICH PANEL WITH UNIDIRECTIONAL COMPOSITE TAPES AND ITS PRODUCTION PROCESS, which published on Jan. 11, 2024, are incorporated herein by reference.

Depending on the manufacturing process used to create a decking plank, or board, 300, further to the above, one or more of the honeycomb cells 314 of the core 310 may be transected to cut the board 300 to an appropriate width. For instance, referring again to FIG. 6, certain cells 314 of the core 310, i.e., cells 314′, have been transected along a first longitudinal side 303 of the board 300 and the openings 313′ defined in the cells 314′ are exposed laterally along the first longitudinal side 303. The cells 314 along a second longitudinal side 304 of the board 300 have been transected in a similar manner. In various embodiments, one or more of the cells 314 of the core 310 may be transected to cut the board to an appropriate length. In such instances, the cells 314 along a first end and/or a second end of the board 300 are transected thereby laterally exposing the openings 313 defined in the transected cells 314. Embodiments are discussed below in which these transected cells are enclosed by an edge finish.

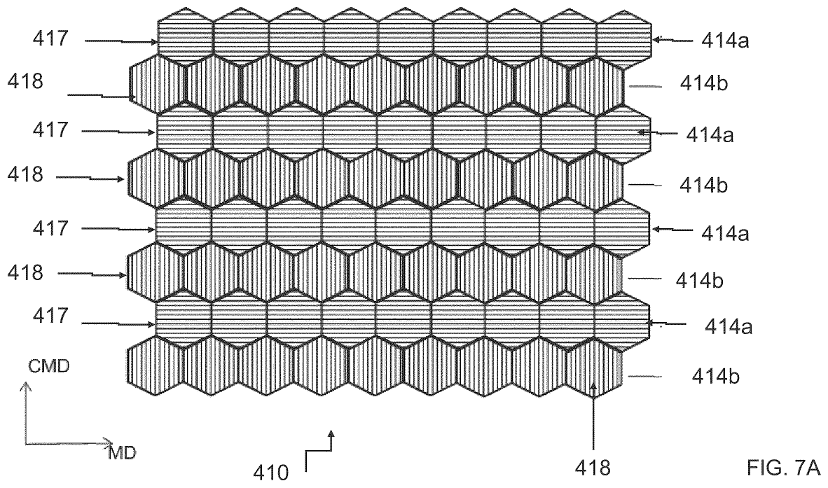

A manufactured composite board, or decking plank, 500 is illustrated in FIG. 8 and is similar to the boards 300 and 400 in many respects. The board 500 comprises a honeycomb core 510, a first layer 120 attached to a bottom side 511 of the core 510, a second layer 130 attached to a top side 512 of the core 510, and an outer layer 140 attached to the second layer 530. Similar to the core 310 and the core 410, the core 510 comprises a plurality of cells 514, with each cell 514 being defined by cell walls 515 and an opening 513 defined in between the cell walls 515. At least some of the cell walls 515 along the perimeter of the board 500 have been transected-to cut the board 500 to a desirable width and/or length-thereby laterally exposing the openings 513 defined in such perimeter cells 514. The board 500 does not have an edge finish that encloses the laterally-exposed openings 513.

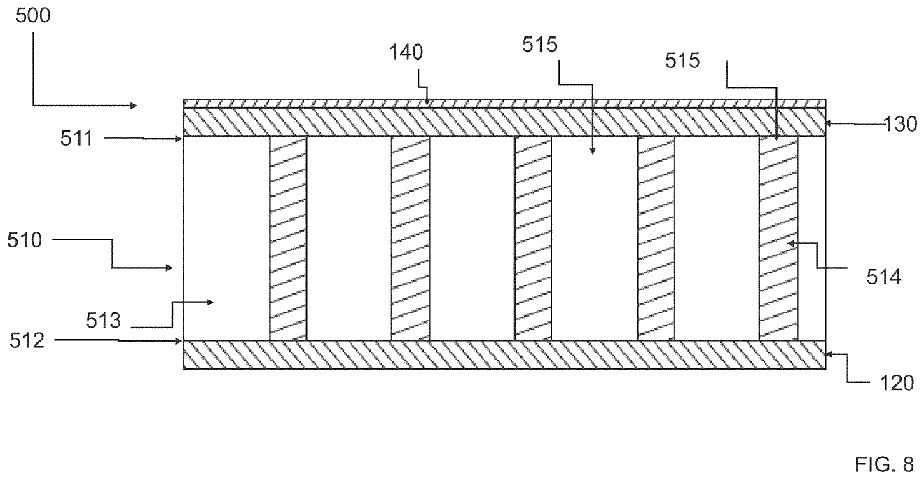

Referring to FIG. 9, a board, or decking plank, 600 comprises a composite including a core 510, a first layer 120 attached to a bottom side of the core 510, a second layer 130 attached to a top side of the core 150, and a top layer 140 attached to the second layer 510. The board 600 further comprises an edgeband 650 attached to the composite. The edgeband 650 is attached to the core 510 and encloses, or at least substantially encloses, the laterally-exposed openings 513 of the cells 514 along the perimeter of the core 510. The edgeband 650 is thermally welded to the cell walls 515 of the core 510. In addition to or in lieu of thermal welding, in various embodiments, the edgeband 650 is attached to the cell walls 515 by one or more adhesives. Moreover, the edgeband 650 is attached to the first layer 120, the second layer 130, and the top layer 140. Similar to the core 510, the first layer 120, the second layer 130, and/or the top layer 140 are transected to cut the board 600 to a desirable width and/or length and the edgeband 650 is attached to the transected edges, i.e., edges 125, 135, and 145, of the first layer 120, the second layer 130, and the top layer 140, respectively. The edgeband 650 is thermally welded to the edges 125, 135, and 145. In addition to or in lieu of thermal welding, in various embodiments, the edgeband 650 is attached to the edges 125, 145, and 145 by one or more adhesives.

In various instances, further to the above, the edgeband 650 and the composite comprising the core 510, the first layer 120, the second layer 130, and the top layer 140 are heated and the edgeband 650 is pressed against the side of the composite to thermally weld the edgeband 650 to the side of the composite. In various embodiments, further to the above, two separate edgebands 650 are attached to the composite-one to a first longitudinal side of the composite and the other to a second, or opposite, longitudinal side. In at least one embodiment, two separate edgebands 650 are attached to the ends of the composite. In various embodiments, edgebands 650 are attached to the longitudinal sides of the composite and the ends of the composite. In at least one embodiment, an edgeband 650 extends around the entire perimeter of the board 600.

Further to the above, referring again to FIG. 9, the edgeband 650 is comprised of at least one thermoplastic, such as high-density polyethylene (HDPE), for example. That said, the edgeband 650 can be comprised of any suitable material. The edgeband 650 has a thickness that is equal to, or at least substantially equal to, the thickness of the top layer 140; however, the edgeband 650 can have any suitable thickness. In various instances, the edgeband 650 is comprised of a material and has a thickness sufficient to structurally bolster the longitudinal sides and/or the ends of the board 600. In at least one instance, the transection of the perimeter cells 514, or more specifically the transection of the walls 515 defining the perimeter cells 514, can weaken the edges of the board 600 and attaching the edgeband 650 to the transected cell walls 515 can strengthen the edges of the board 600.

In various embodiments, further to the above, an edgeband 650 can be applied to an edge of a board that has not been transected. Referring again to FIG. 7, the board 400 has a first longitudinal side 403 and a second longitudinal side 404 that are created when the board 400 is cut from a composite sheet. As a result, the walls 415 defining cells 414′ along the longitudinal sides 403, 404 of the board 400 have been transected and an edgeband 650 applied to the first longitudinal side 403 and/or the second longitudinal side 404 can provide a pleasing aesthetic effect to the board 400 and/or strengthen the board 400. Notably, the cells 414 along at least one of the ends of the board 400 have not been transected, as can be seen in FIG. 7. Rather, owing to the manner in which the material 410′ is folded, some of the walls 415, or recessed walls 415, of the cells 414 at the end of the board 400 are recessed with respect to the walls 415, or end walls 415, of other cells 414 at the end of the board 400. An edgeband 650 applied to the end of the board 400 can be attached to the end walls 415, enclose the recessed walls 415, and support the edges of the board 400. Similarly, the core 510 comprises recessed walls 515 that define spaces that can be enclosed, or at least substantially enclosed, by an edgeband 650.

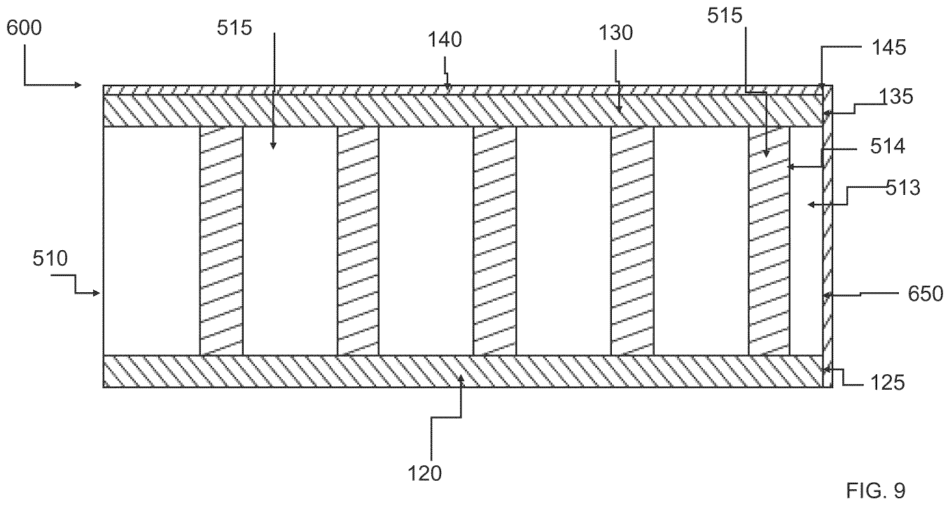

Referring to FIG. 10, a board, or decking plank, 700 comprises a composite including a core 510, a first layer 120 bonded to a bottom side of the core 510, a second layer 730 bonded to a top side of the core 510, and a wrap shell 740. The second layer 730 comprises a top face and the wrap shell 740 is bonded to the top face of the second layer 730. The wrap shell 740 also wraps around the sides and/or ends of the board 700 and is bonded to the lateral sides and/or ends of the second layer 730, the core 510, and the first layer 120. The wrap shell 740 is thermally welded to the cell walls 515 of the core 510. In addition to or in lieu of thermal welding, in various embodiments, the wrap shell 740 is attached to the cell walls 515 by one or more adhesives. Similarly, the wrap shell 740 is thermally welded to the first layer 120 and the second layer 730. In addition to or in lieu of thermal welding, in various embodiments, the wrap shell 740 is attached to the first layer 120 and the second layer 730 by one or more adhesives. As a result of the above, the wrap shell 740 encloses, or at least substantially encloses, any laterally-exposed openings 513 of transected cells 514 along the perimeter of the core 510. Also, as a result of the above, the wrap shell 740 encloses, or at least substantially encloses, any spaces created in the core 510 by recessed walls 515.

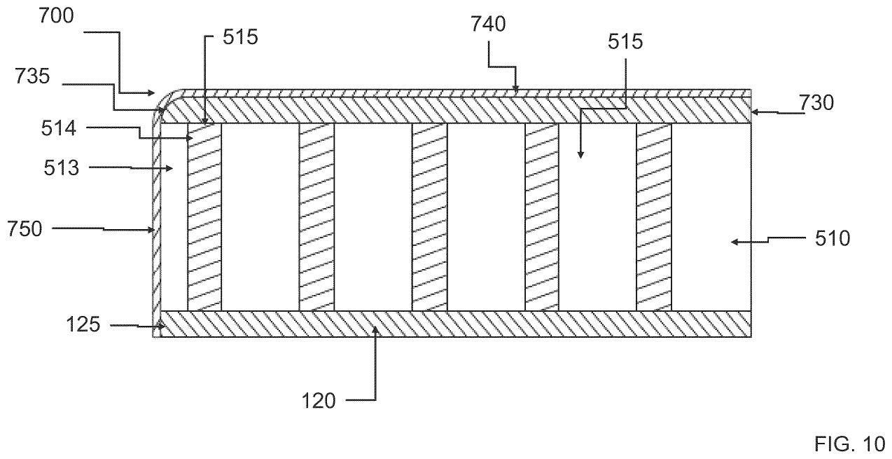

Referring to FIG. 11, a board, or decking plank, 1100 comprises a composite including a core 510, a first layer 120 attached to a bottom side of the core 510, a second layer 130 attached to a top side of the core 510, and a top layer 140 attached to the second layer 130. The board 1100 further comprise an edge profile 1150 attached to the composite. The edge profile 1150 is attached to the core 510 and encloses, or at least substantially encloses, any laterally-exposed openings 513 of transected cells 514 along the perimeter of the core 510. The edge profile 1150 also encloses, or at least substantially encloses, any spaces created in the core 510 by recessed walls 515. In various embodiments, the edge profile 1150 is thermally welded to the cell walls 515 of the core 510. In at least one embodiment, the edge profile 1150 is attached to the cell walls 515 by one or more adhesives. Moreover, the edge profile 1150 is attached to the first layer 120, the second layer 130, and/or the top layer 140. More specifically, in various embodiments, the edge profile 1150 is thermally welded to the edges 125, 135, and 145 of the first layer 120, the second layer 130, and the top layer 140, respectively. In at least one embodiment, the edge profile 1150 is attached to edges 125, 135, and 145 by one or more adhesives. In various embodiments, an edge profile 1150 is co-extruded onto the composite comprising the core 510, the first layer 120, the second layer 130, and the top layer 140.

Further to the above, referring again to FIG. 11, an edge profile 1150 is attached to one or more edges of the board 1100. For instance, in various embodiments, an edge profile 1150 is attached to a first longitudinal edge of the board 1100, a second longitudinal edge of the board 1100, a first end of the board 1100, and/or a second end of the board 1100. In at least one embodiment, an edge profile 1150 extends around the entire perimeter of the board 1100. In various embodiments, all of the edges of the board 1100 are covered by an edge profile 1150 while, in other embodiments, less than all of the edges of the board 1100 are covered by an edge profile 1150. For instance, in at least one embodiment, the first longitudinal side of the board 1100 and the second longitudinal side of the board 1100 are covered by an edge profile 1150 while the ends of the board 1100 are uncovered by an edge profile. In any event, the edge profile 1150 becomes structurally part of the composite comprising the core 510, the first layer 120, the second layer 130, and the top layer 140 once the edge profile 1150 is attached to the composite. As illustrated in FIG. 11, the edge profile 1150 comprises a groove 1155 defined therein configured to receive a fastener clip as described above. In various embodiments, the top surface of the edge profile 1150 is aligned with, or co-planar with, the top surface of the top layer 140 such that a stepped edge between the edge profile 1150 and the top layer 140 is not present or at least not readily noticeable.

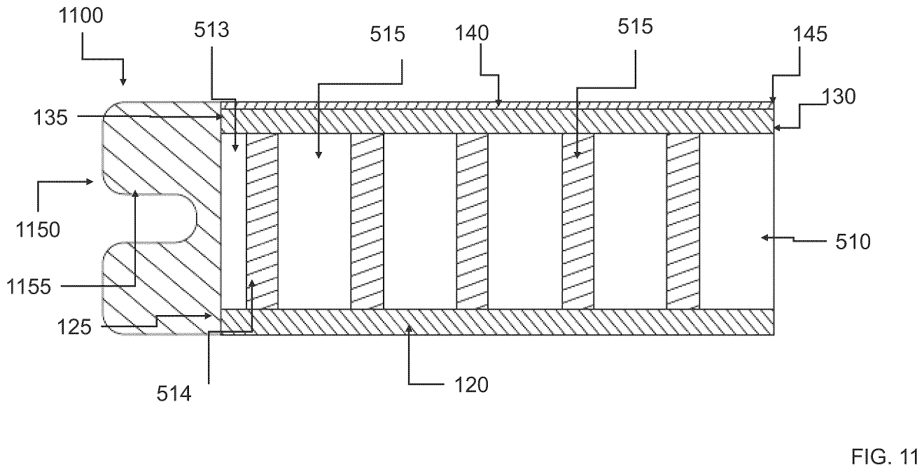

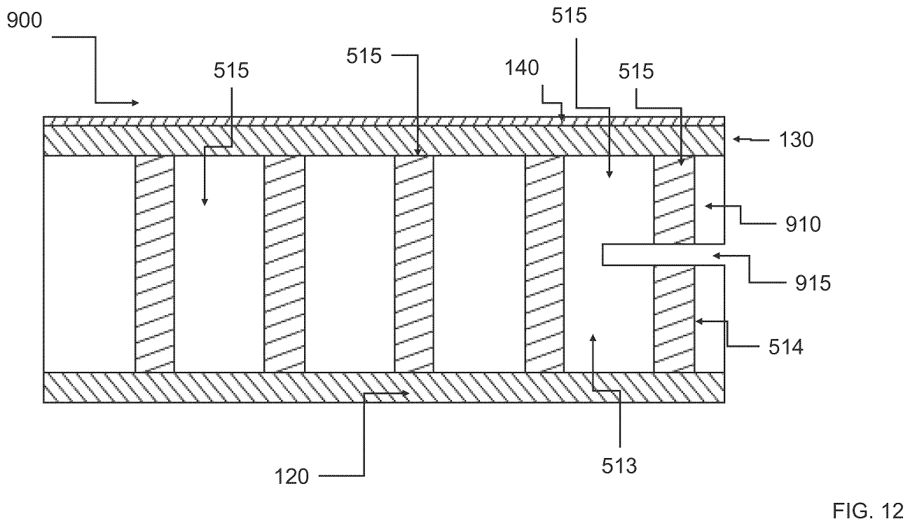

A decking plank, or board, 900 is illustrated in FIGS. 12 and 13 and is similar to the board 1100 in many respects. The board 900 comprises a folded honeycomb core 910 that is similar to the core 510, a first layer 120 attached to a bottom side of the core 910, a second layer 130 attached to a top side of the core 910, and a top layer 140 attached to a top surface of the second layer 140. Moreover, instead of an edge profile 1150, the board 900 comprises an edge profile 950. The edge profile 950 is similar to the edge profile 1150 but it also includes a securing flange, or rib, 955 that extends into a groove 955 defined in the core 910. The groove 915 is cut into the side of the core 910 and transects some of the walls 515 of the cells 514 which tends to weaken the core 910; however, the rib 955 is closely received within the groove 915 such that the rib 955 supports the transected walls 515, especially after the rib 955 has been thermally bonded to the core 910 and/or bonded to the core 910 using one or more adhesives. In at least one embodiment, the rib 955 is press-fit within the groove 915.

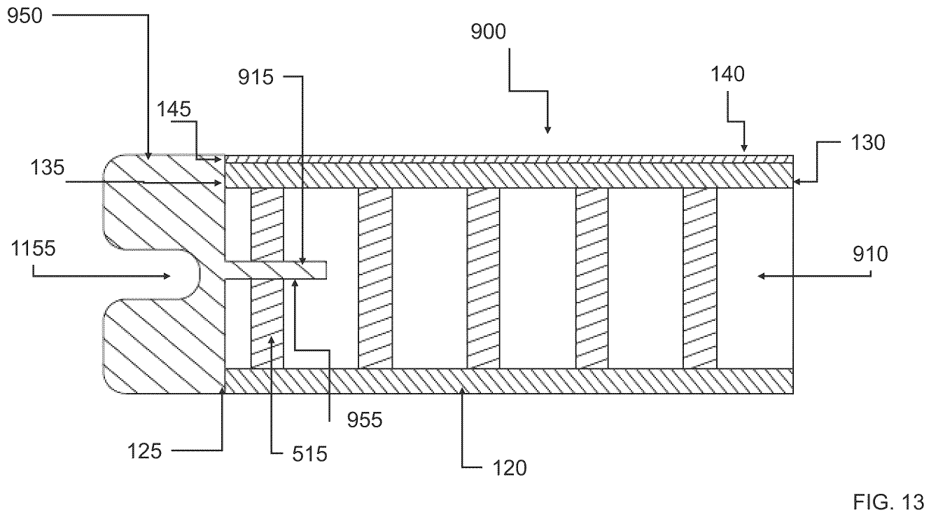

A decking plank, or board, 1000 is illustrated in FIG. 14 and is similar to the board 1100 in many respects. The board 1000 comprises a composite including a folded honeycomb core 510, a first layer 120 attached to a bottom side of the core 510, a second layer 130 attached to a top side of the core 510, and a top layer 140 attached to a top surface of the second layer 140. Moreover, instead of an edge profile 1150, the board 1000 comprises an edge profile 1050 attached to the composite. The edge profile 1050 is attached to the first layer 120 and the top layer 140 and encloses, or at least substantially encloses, any laterally-exposed openings 513 of transected cells 514 along the perimeter of the core 510. The edge profile 1050 also encloses, or at least substantially encloses, any spaces created in the core 510 by recessed walls 515. The edge profile 1050 comprises a shell having a first end attached to an edge 125 of the first layer 120 and a second end attached to an edge 145 of the top layer 140. In various embodiments, the edge profile 1050 is thermally welded to the edges 125 of the first layer 120 and the edges 145 of the top layer 140. In at least one embodiment, the edge profile 1050 is attached to the edges 125 and 145 by one or more adhesives. The shell of the edge profile 1050 defines an interior space 1055 and, as a result, the edge profile 1050 can be substantially lighter than the edge profile 1150. In various embodiments, an edge profile 1050 is co-extruded onto the composite comprising the core 510, the first layer 120, the second layer 130, and the top layer 140.

In various instances, further to the above, the edge profile 1050 and the composite comprising the core 510, the first layer 120, the second layer 130, and the top layer 140 are heated and the edge profile 1050 is pressed against the side of the composite to thermally weld the edge profile 1050 to the side of the composite. In various embodiments, further to the above, two separate edge profiles 1050 are attached to the composite-one to a first longitudinal side of the composite and the other to a second, or opposite, longitudinal side. In at least one embodiment, two separate edge profiles 1050 are attached to the ends of the composite. In various embodiments, edge profiles 1050 are attached to the longitudinal sides and the ends of the composite. In at least one embodiment, an edge profile 1050 extends around the entire perimeter of the board 1000. In at least one such embodiment, the interior space 1055 can extend around the perimeter of the board 1050.

Further to the above, referring again to FIG. 14, the edge profile 1050 is comprised of at least one thermoplastic, such as high-density polyethylene (HDPE), for example. That said, the edge profile 1050 can be comprised of any suitable material. The edge profile 1050 has a thickness that is equal to, or at least substantially equal to, the thickness of the top layer 140; however, the edge profile 1050 can have any suitable thickness. In various instances, the edge profile 1050 is comprised of a material and has a thickness sufficient to structurally bolster the longitudinal sides and/or the ends of the board 1000. In at least one instance, the transection of the perimeter cells 514, or more specifically the walls 515 defining the perimeter cells 514, can weaken the edges of the board 1000 and attaching the edge profile 1050 to the transected cell walls 515 can strengthen the edges of the board 1000.

In various embodiments, further to the above, a board can have an entire perimeter thereof covered by the same type of edge profile. In other embodiments, a board can have two or more different types of edge profiles attached to the perimeter thereof. For instance, a board can have an edge profile 950 attached to a first longitudinal side of the board, an edge profile 1050 attached to a second longitudinal side of the board, and an edgeband 650 attached to each end of the board, for example.

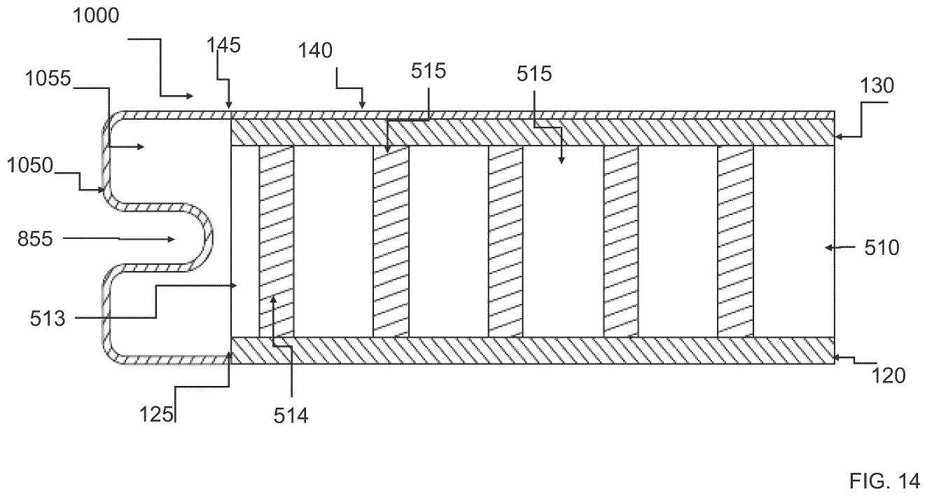

In addition to or in lieu of an edge profile being attached to an edge of a board, one or more edges of the board can be modified to create an edge profile. Referring to FIG. 15, an edge of a board 500 has been thermoformed to create a modified board 500′. In at least one instance, the longitudinal sides of a board 500 are heated and compressed to at least partially close any transected cells 514 along the longitudinal sides. In various instances, any edge of a board 500 can be heated and compressed to at least partially close any spaces defined by and/or between cells 514 along the perimeter of the board 500. In various instances, the entire board 500 is heated and the edges of the board 500 are compressed to make the modified board 500′. In other instances, only the edges of the board 500 are heated. In various instances, the edges are heated and then compressed. In other instances, the edges are heated while they are being compressed. In various instances, the board 500, or at least a portion of the board 500, is heated to a temperature that equals or exceeds the melting temperature of a thermoplastic material in the first layer 120, the melting temperature of a thermoplastic material in the second layer 130, the melting temperature of a thermoplastic material in the top layer 140, and the melting temperature of a thermoplastic material in the core 510 when thermoforming the board 500. In at least one embodiment, the core 510, the first layer 120, the second layer 130, and the top layer 140 are at least partially comprised of polyethylene and are heated to a temperature of at least 115 degrees Celsius, for example. The thermoformed edge of the modified board 500′ has a rounded top corner and a rounded bottom corner. At the rounded top corner, the edge 135 of the layer 130, the edge 145 of the layer 140, and a portion of the core 510 are rounded toward a center line CL of the board 500. At the rounded bottom corner, the edge 125 of the layer 120 and a portion of the core 510 are also rounded toward the board center line CL. Such an arrangement can provide a pleasing aesthetic effect, strengthen the edges of the modified board 500′, and/or reduce wear on the modified board 500′.

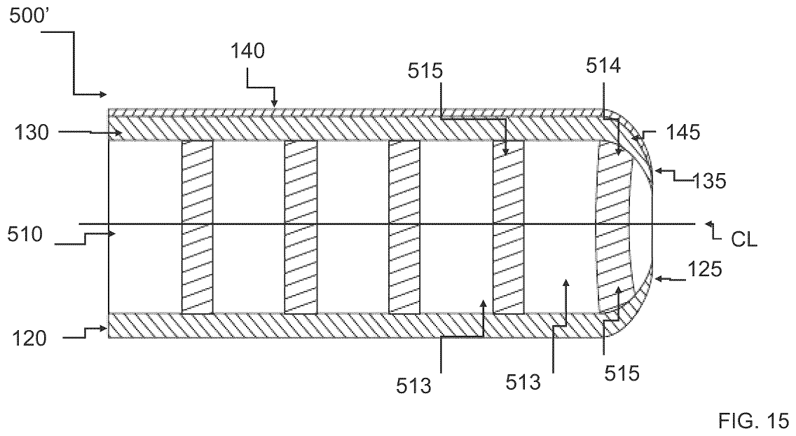

Referring to FIG. 16, an edge of a board 500 has been thermoformed to create a modified board 500″. In at least one instance, the longitudinal sides of a board 500 are heated and compressed to at least partially close any transected cells 514 along the longitudinal sides. In various instances, any edge of a board 500 can be heated and compressed to at least partially close any spaces defined by and/or between cells 514 along the perimeter of the board 500. In various instances, the board 500, or at least a portion of the board 500, is heated to a temperature that equals or exceeds the melting temperature of a thermoplastic material in the first layer 120, the melting temperature of a thermoplastic material in the second layer 130, the melting temperature of a thermoplastic material in the top layer 140, and the melting temperature of a thermoplastic material in the core 510 when thermoforming the board 500. In at least one embodiment, the core 510, the first layer 120, the second layer 130, and the top layer 140 are at least partially comprised of polyethylene and are heated to a temperature of at least 115 degrees Celsius, for example. The thermoformed edge of the modified board 500″ has a pinched configuration. The edge 135 of the layer 130, the edge 145 of the layer 140, and a portion of the core 510 have been pushed or compressed downwardly past a center line CL of the board 500 toward the bottom of the modified board 500″. At the bottom of the modified board 500″, the bottom layer 120 has also been compressed. Such an arrangement can be created by supporting the bottom of a heated board 500 and pushing downwardly on the top layer 140. Moreover, such an arrangement can provide a pleasing aesthetic effect, strengthen the edges of the modified board 500″, and/or reduce wear on the modified board 500″.

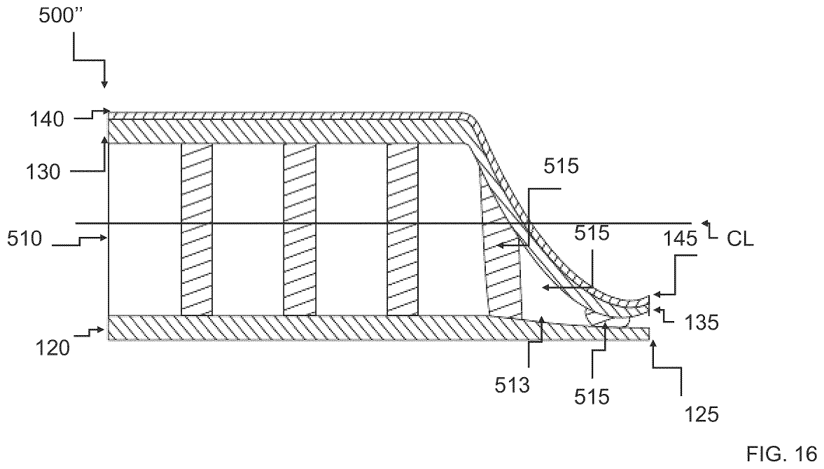

Referring to FIG. 17, an edge of a board 500 has been thermoformed to create a modified board 500′″. In at least one instance, the longitudinal sides of a board 500 are heated and compressed to at least partially close any transected cells 514 along the longitudinal sides. In various instances, any edge of a board 500 can be heated and compressed to at least partially close any spaces defined by and/or between cells 514 along the perimeter of the board 500. In various instances, the board 500, or at least a portion of the board 500, is heated to a temperature that equals or exceeds the melting temperature of a thermoplastic material in the first layer 120, the melting temperature of a thermoplastic material in the second layer 130, the melting temperature of a thermoplastic material in the top layer 140, and the melting temperature of a thermoplastic material in the core 510 when thermoforming the board 500. The thermoformed edge of the modified board 500′″ has a profiled configuration. The edge 125 of the layer 120, the edge 135 of the layer 130, the edge 145 of the layer 140, and a portion of the core 510 have been pushed or compressed inwardly along a center line CL of the board 500. At the bottom of the modified board 500″, the bottom layer 120 has curled upwardly toward the board center line CL. Such an arrangement can be created by pushing inwardly into the side of a heated board 500. Moreover, such an arrangement can provide a pleasing aesthetic effect, strengthen the edges of the modified board 500″, and/or reduce wear on the modified board 500″.

As discussed herein, a layer of a board can be thermally bonded directly to a core and/or another layer of the board. In various instances, the materials comprising the core and the layers of a board are selected to achieve various performance and/or structural parameters. In some instances, however, one or more of the materials selected to achieve such performance and/or structural parameters may not create the best thermal bond between the core and the layers. In various embodiments, a low-melt tie layer can be positioned between the core and a layer, for example, that has a lower melt temperature than the core and the layer which improves the thermal bond between the core and the layer. In some embodiments, the low-melt tie layer comprises a thermoplastic material that can melt and flow into crevices, for example, in the surfaces of the core and the layer and interlock the core and the layer together when the material comprising the low-melt tie layer cools and re-solidifies. Similarly, a low-melt tie layer can be positioned between two adjacent layers of a board to achieve a similar result. In various embodiments, a low-melt tie layer can comprise one or more adhesives that at least partially liquify at a temperature that is below the melt temperature of the core and/or the layers of a board and then assume an at least partially amorphous state connecting the core and/or layers once the one or more adhesives have cooled. In any event, one or more low-melt tie layers can be used in any of the embodiments disclosed herein.

In various embodiments, further to the above, an edge profile can be mechanically attached to a core of a manufactured decking plank, or board. In at least one embodiment, the edge profile comprises a clip, or clamp, that grips the core and/or one or more layers attached to the core. In at least one embodiment, the edge profile is fastened to the core, and/or one or more layers attached to the core, by one or more fasteners, such as screws, tacks, and/or nails, for example. In at least one embodiment, the edge profile comprises one or more barbs extending therefrom that bite into and/or through the core, layers attached to the core, and/or a decorative layer attached to one or more of the layers attached to the core.

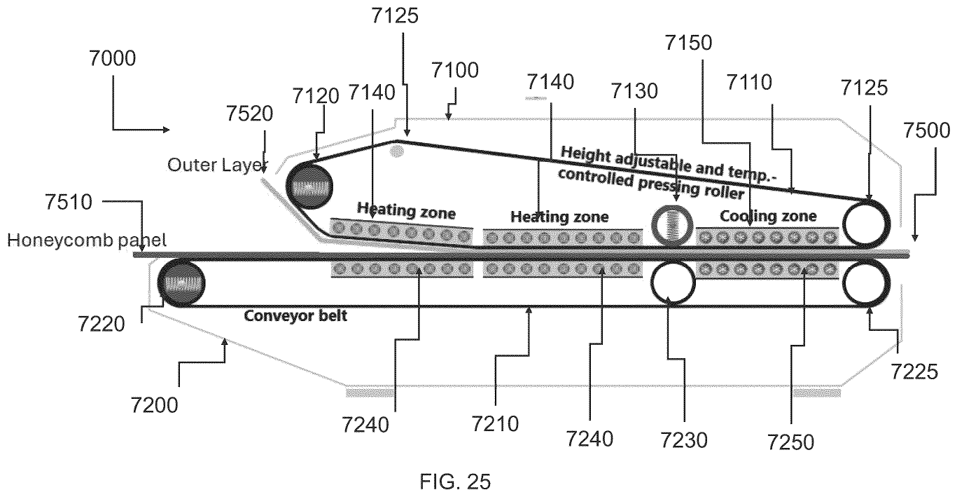

A manufactured decking plank, or board, 8000 is illustrated in FIG. 26. The board 8000 comprises a core 8010, a first layer 8020 attached to a first side of the core 8010, and a second layer 8030 attached to a second, or opposite, side of the core 8010. The first layer 8020 and the second layer 8030 are thermally bonded to the core 8010, but they can be attached to the core 8010 in any suitable manner to form a composite assembly. The board 8000 further comprises a top layer 8040 mechanically attached to the composite assembly. More specifically, the top layer 8040 comprises integral edge profiles 8050 that are clamped onto the composite assembly. As a result of this arrangement, the top layer 8040, and the integral edge profiles 8050, do not need to be thermally bonded to the composite assembly and/or adhered to the composite assembly. Similar to the above, the edge profiles 8050 each comprise a slot 8055 defined therein that is configured to receive a fastener, such as a fastener 8090, for example, that is configured to mount the board 8000 to a deck frame, for example. The fastener 8090 is T-shaped and comprises a first flange that extends into the slot 8055 of a first board 8000 and a second flange that extends into the slot 8055 of an adjacent second board 8000.

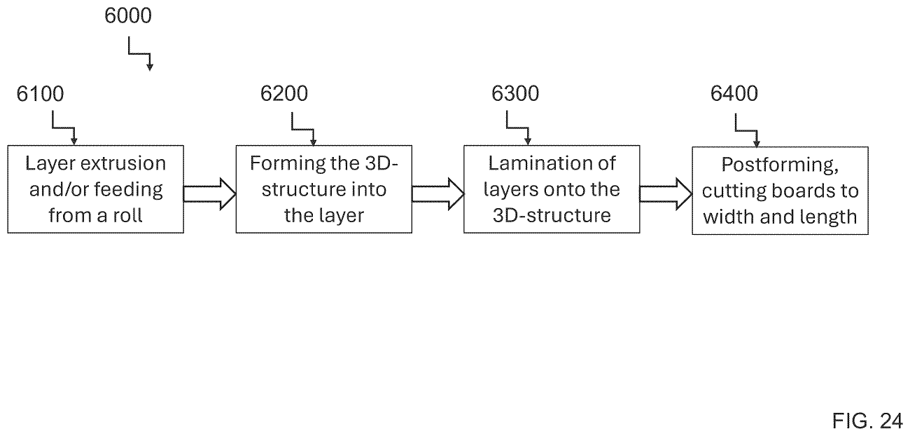

A belt press 7000 is illustrated in FIG. 25. The belt press 7000 can be used to apply one or more layers, such as any of the layers disclosed herein, for example, to a core, such as any of the cores disclosed herein, for example, to form a manufactured decking plank, or board. For instance, the belt press 7000 is configured to apply a layer 7520 to a core 7510 to form a board 7500 using a thermal bonding process. The belt press 7000 comprises a first side 7100 comprising a motor-driven first belt 7110 and a second side 7200 comprising a motor-driven second belt 7210 that are operable to pull the core 7510 and the layer 7520 into a space defined between the first belt 7110 and the second belt 7210. The first side 7100 comprises a first electric motor and a first drive wheel 7120 mounted to the output shaft of the first electric motor that is configured to engage the second layer 7520 and pull the second layer 7520 into the belt press 7500. The first side 7100 further comprises one or more bearing wheels 7125 that, together with the first drive wheel 7120, define a circuit for the first belt 7110. The first side 7100 further comprises a compression system 7130 configured to apply a compressive force to the core 7510 and the layer 7520 as they pass under the compression system 7130. Similarly, the second side 7200 comprises a second electric motor and a second drive wheel 7220 mounted to the output shaft of the second electric motor that is configured to engage the core 7510 and pull the core 7510 into the belt press 7500. The second side 7200 further comprises one or more bearing wheels 7225 that, together with the second drive wheel 7220, define a circuit for the second belt 7210. The second side 7200 further comprises a compression bearing wheel 7230 aligned with the compression system 7130 that can co-operatively compress the core 7510 and the layer 7520 with the compression system 7130. The belt press 7000 further comprises heating elements 7140 and 7240 that heat the core 7510 and/or the layer 7520 to a sufficient temperature such that the core 7510 and the layer 7520 are thermally bonded together as they pass through the belt press 7000. The belt press 7000 further comprises one or more cooling elements 7150 and 7250 that cool the core 7510 and/or the layer 7520 to a temperature that inhibits the core 7510 and the layer 7520 from separating, or delaminating, from one another and/or undesirably deforming as they exit the belt press 7000.

In various embodiments, a core of a manufactured decking plank, or board, can be comprised of honeycomb cells cut from a tube, for example. In at least one embodiment, a round tube comprised of at least one thermoplastic material and wood pieces, such as sawdust, for example, intermixed in the thermoplastic material is formed and then cut into tube segments. In at least one such embodiment, the tube segments are 2 feet long, for example. The tube segments are then stacked in a frame and a tie layer is positioned over the stacked tube segments. In addition to or in lieu of such a tie layer, a tie layer can be positioned under the stacked tube segments in the frame. In certain embodiments, each tube segment can have a tie layer attached to an end thereof before the tube segments are stacked in the frame. In any event, the frame is inserted into an oven, such as an autoclave, for example, once the tube segments are stacked in the frame. In the oven, the tie layers are at least partially melted to fuse the tube segments together to form a large honeycomb block. In certain embodiments, the oven can be heated to a temperature that partially melts, or at least softens, the tube segments such that the tube segments directly fuse together. After the large honeycomb block has sufficiently cooled, it is cut, with a horizontal saw, for example, to form honeycomb panels, or board cores, having round cells that are connected to one another-either directly and/or via one or more tie layers. At such point, one or more layers can be attached to the cores as discussed herein, if desired, to create decking planks, or boards.

As discussed herein, wood, such as sawdust, for example, can be intermixed with one or more thermoplastic materials to create a thermoplastic composite that forms the core and/or layers of a manufactured decking plank, or board. In various embodiments, the core and the layers of a board have the same mass percentage of wood in the thermoplastic composite comprising the same. For instance, the core and the layers each have a 15% mass percentage of wood in the thermoplastic composite, or composites, comprising the core and the layers. In such an embodiment, the thermoplastic composite is flexible enough to be folded and/or thermoformed as described herein to form the core of the board, for example. In various instances, the core and the layers each have a 20% mass percentage of wood in the thermoplastic composite, for example, which also allows the core material to be folded and/or thermoformed as described herein. In various instances, the core and/or the layers of a board can have between 15% and 60% mass percentage of wood in a thermoplastic composite comprising the core and/or layers, for example.

In various embodiments, the mass percentage of wood in the thermoplastic composite material that forms a layer of a board is different than the mass percentage of wood in the thermoplastic composite material that forms the core of the board. In at least one embodiment, the material forming the core of a board has between 15% and 20% mass percentage of wood and the material forming a layer attached to the core has more than 20% mass percentage of wood, for example. In at least one embodiment, the material forming the layer has between 20% and 60% mass percentage of wood, for example. In such embodiments, the core is sufficiently flexible to be folded and/or thermoformed while having sufficient structural stiffness. Also, in such embodiments, the layer has sufficient wear resistance, for example, and/or surface traction if the layer is the top layer of the board. In various embodiments, a board comprises a core comprised of a first polyethylene composite having a first mass percentage of wood in the first polyethylene composite, a bottom layer attached to the bottom of the core comprised of a second polyethylene composite having a second mass percentage of wood in the second polyethylene composite, and a top layer attached to the top of the core comprised of a third polyethylene composite having a third mass percentage of wood in the third polyethylene composite, wherein the first mass percentage of wood, the second mass percentage of wood, and the third mass percentage of wood are different. In at least one such embodiment, the first mass percentage of wood is less than the second mass percentage of wood and the third mass percentage of wood. Such an embodiment can have a foldable core and stiff outer surfaces, for example. In at least one embodiment, the first polyethylene composite of the core has a mass percentage of wood between 15% and 20%, the second polyethylene composite of the bottom layer has a mass percentage of wood between 15% and 60%, and the third polyethylene composite of the top layer has a mass percentage of wood between 40% and 70%, for example. In various embodiments, the top layer of a board has the highest mass percentage of wood as compared to the core and the other layers of the board. In such embodiments, the top layer can be the furthest away from the neutral axis of the board than the other layers and can provide a high degree of stiffness at the surface of the board, as well as a high degree of wear resistance, for example.

In various embodiments, further to the above, an edge profile of a board is comprised of a polyethylene composite comprising wood, such as sawdust, for example, mixed into polyethylene. In at least one embodiment, the mass percentage of wood in the polyethylene composite used to make an edge profile of a board is greater than the mass percentage of wood in a polyethylene composite used to make the core of the board. In at least one such embodiment, the mass percentage of wood in the polyethylene composite of the edge profiles of a board is between 40% and 60%, for example, and the mass percentage of wood in the polyethylene composite of the core is between 15% and 20%, for example. In at least one embodiment, the mass percentage of wood in the polyethylene composite of the edge profiles is the same as the mass percentage of wood in the polyethylene composite used to make the top layer of the board.

In various embodiments, further to the above, a material used to form the core, a layer, and/or an edge profile of a board can comprise a reinforcing filler mixed into the material. Such a reinforcing filler can be used in addition to, or in lieu of, wood mixed into the material, as discussed above. The reinforcing filler can comprise fiberglass, mineral, plastic fiber, and/or organic materials, for example. In various embodiments, the reinforcing filler is between 15% and 60% mass percentage in the composite material, for example. In at least one embodiment, the core of a board is comprised of a polyethylene composite including 15% mass percentage of wood and 10% mass percentage of another reinforcing filler, for example.

As discussed herein, a manufactured decking plank, or board, can comprise a core having one or more cells defined therein that reduces the weight of the board as compared to a solid manufactured board without such one or more cells. In various embodiments, the weight reduction can be as much as 50% while, in certain embodiments, the weight reduction can be as much as 80%, for example.

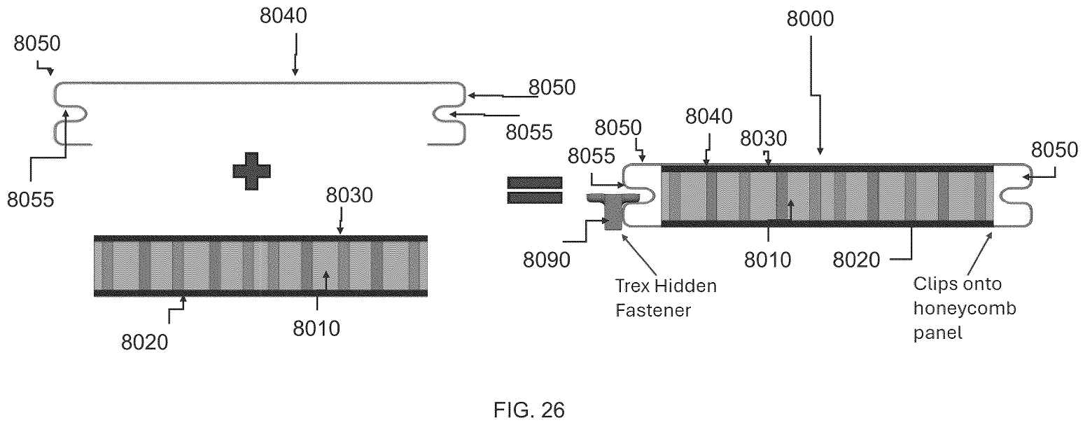

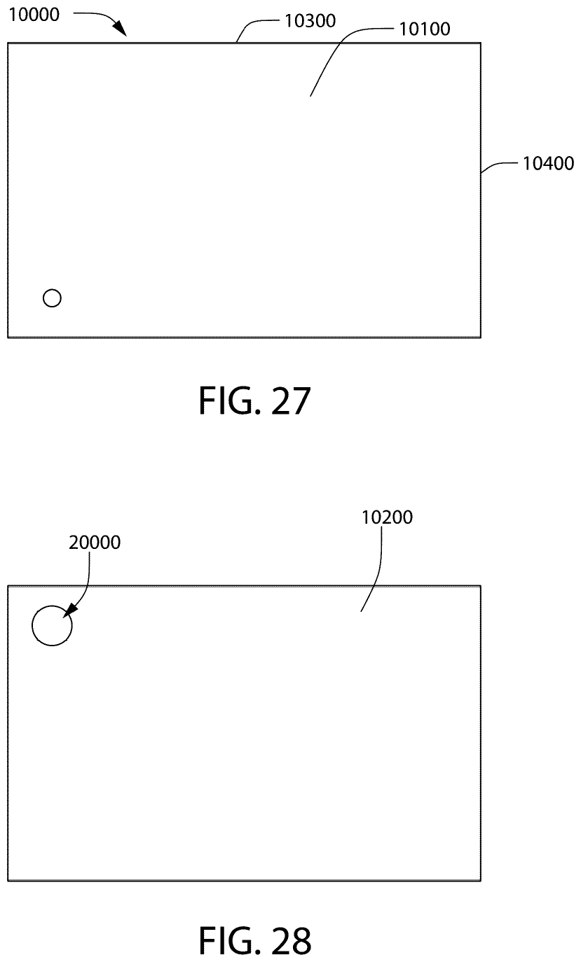

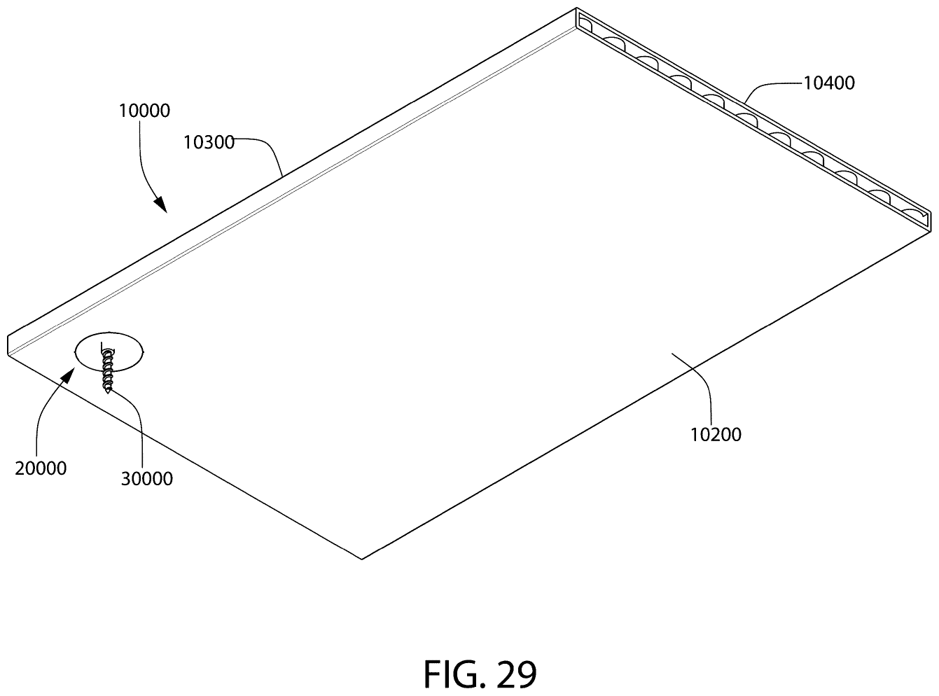

Further to the above, a fascia panel can be attached to a deck structure to provide a desirable aesthetic appearance, for instance. A fascia panel 10000 is illustrated in FIGS. 27-29. The fascia panel 10000 comprises an outward-facing sheet, or side, 10100 and an inward-facing sheet, or side, 10200 opposite the outward-facing sheet 10100. In use, the inward-facing sheet 10200 can be positioned against the deck structure such that the outward-facing sheet 10100 faces away from the structure. The outward-facing sheet 10100 comprises a planar wall, but can comprise any suitable configuration. Similarly, the inward-facing sheet 10200 comprises a planar wall, but can comprise any suitable configuration. The fascia panel 10000 further comprises inner walls 10400 connecting the outward-facing sheet 10100 and the inward-facing sheet 10200. The inner walls 10400 define honeycomb cells within the fascia panel 10000. The cells comprise a core including empty spaces defined therein; however, other embodiments are envisioned in which the cells include one or more materials therein. The fascia panel 10000 comprises a rectangular shape defined by a perimeter including longitudinal edges 10300 and lateral edges 10600, but can comprise any suitable configuration. The longitudinal edges 10300 are closed whereas the lateral edges 10600 are open leaving one or more cells exposed. That said, the longitudinal edges 10300 and/or the lateral edges can be open and/or closed as desired. In various instances, the fascia panel 10000 comprises one or more fastener assemblies 20000 that comprise, among other things, convenient locations to mount the fascia panel 10000 to a structure using screws 30000, for example. The fascia panel 10000, and/or any other fascia panel, can be made using any of the materials, structures, methods, and/or processes disclosed herein, among others.

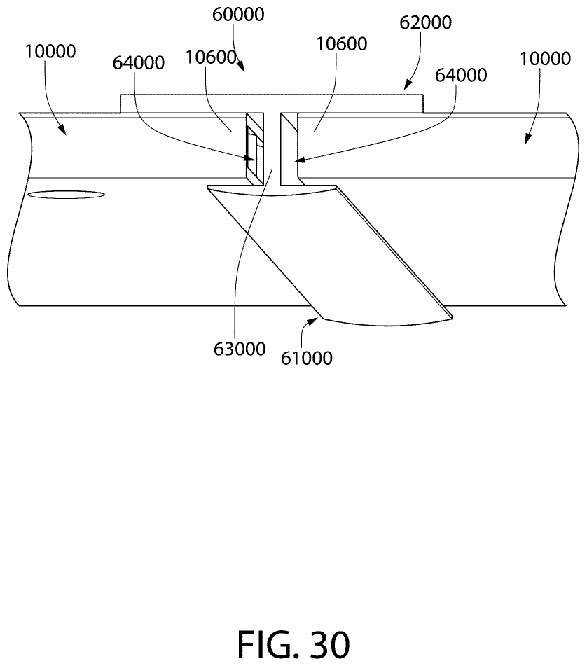

Further to the above, the lateral edges 10600 of the fascia panel 10000 have open cells along the length thereof which can be unaesthetic. In various instances, referring to FIG. 30, a trim 60000 can be used to hide such lateral edges 10600, for example. The trim 60000 comprises a front face 61000, a rear face 62000, and a web 63000 connecting the front face 61000 and the rear face 62000. The front face 61000, the rear face 62000, and the web 63000 collectively define slots 64000 therein which are each configured to receive a lateral edge 10600 of a fascial panel 10000 therein and hide the open cells of the lateral edge 10600 to provide an aesthetic appearance. In various instances, trim can refer to, but is not limited to, decorative material used to beautify and/or protect support columns, posts, joists, rafters, trusses, and/or stair risers, for example. In various instances, cellular (or foamed) polyvinyl chloride (PVC) is used to construct trim, but trim can be comprised of any suitable material. The trim 60000, and/or any other trim, can be made using any of the materials, structures, methods, and/or processes disclosed herein, among others.

While the foregoing description and drawings represent exemplary embodiments of the present disclosure, it will be understood that various additions, modifications and substitutions may be made therein without departing from the spirit and scope and range of equivalents of the accompanying claims. In particular, it will be clear to those skilled in the art that the present invention may be embodied in other forms, structures, arrangements, proportions, sizes, and with other elements, materials, and components, without departing from the spirit or essential characteristics thereof. In addition, numerous variations in the methods/processes described herein may be made within the scope of the present disclosure. One skilled in the art will further appreciate that the embodiments may be used with many modifications of structure, arrangement, proportions, sizes, materials, and components and otherwise, used in the practice of the disclosure, which are particularly adapted to specific environments and operative requirements without departing from the principles described herein. The presently-disclosed embodiments are therefore to be considered in all respects as illustrative and not restrictive. The appended claims should be construed broadly, to include other variants and embodiments of the disclosure, which may be made by those skilled in the art without departing from the scope and range of equivalents.

1. A manufactured deck board, comprising:
a core comprised of a folded material, wherein the core comprises a first face and a second face opposite the first face;
a first layer attached to the first face; and
a second layer attached to the second face.

2. The manufactured deck board of claim 1, wherein the core is comprised of a polymeric material and a cellulosic material embedded in the polymeric material.

3. The manufactured deck board of claim 2, wherein the cellulosic material comprises wood dust.

4. The manufactured deck board of any one of claim 2, wherein the polymeric material comprises a first polymeric material having a first melt temperature, and wherein the core comprises a second polymeric material having a second melt temperature that is higher than the first melt temperature.

5. The manufactured deck board of any one of claim 1, wherein the first layer is comprised of a polymeric material and a cellulosic material embedded in the polymeric material of the first layer.

6. The manufactured deck board of claim 5, wherein the cellulosic material of the first layer comprises wood dust.

7. (canceled)

8. (canceled)

9. The manufactured deck board of any one of claim 1, wherein the second layer comprises an outward face facing away from the core, and wherein the outward face comprises an embedded wood grain pattern.

10. The manufactured deck board of any one of claim 1, further comprising an outer layer attached to the second layer, wherein the outer layer comprises an embedded wood grain pattern.

11. The manufactured deck board of claim 10, wherein the core comprises a lateral core perimeter, and wherein the outer layer comprises an edge profile attached to the lateral core perimeter.

12. The manufactured deck board of claim 1, further comprising a lateral board perimeter and an edge profile attached to the lateral board perimeter.

13. The manufactured deck board of claim 12, wherein the edge profile comprises a cavity defined therein, and wherein the cavity faces the core.

14. The manufactured deck board of claim 12, wherein the core comprises a plurality of honeycomb cells, wherein each cell is defined by cell walls, and wherein the edge profile encloses voids between the edge profile and the cell walls.

15. The manufactured deck board of claim 14, wherein the core comprises a core perimeter, wherein the honeycomb cells along the core perimeter comprise perimeter cells, wherein the cell walls of one or more perimeter cells comprise a slot defined therein, and wherein the edge profile comprises a projection extending into the slot.

16. The manufactured deck board of claim 15, wherein the projection is secured to the core within the slot.

17. The manufactured deck board of any one of claim 1, further comprising a board perimeter and an edgeband attached to the board perimeter.

18. The manufactured deck board of any one of claim 1, further comprising a thermoformed perimeter comprising a thermoformed edge profile.

19. The manufactured deck board of claim 18, wherein the thermoformed edge profile comprises a rounded profile.

20. The manufactured deck board of claim 18, further comprising a board center plane extending through the core, wherein the thermoformed edge profile comprises a pinched profile, and wherein the second layer crosses the board center plane to form the pinched profile.

21. The manufactured deck board of any one of claim 1, wherein the core comprises a plurality of honeycomb cells.

22. A manufactured deck board, comprising:
a core comprised of a dimpled material, wherein the core comprises a first face and a second face opposite the first face;
a first layer attached to the first face; and
a second layer attached to the second face.

23-184. (canceled)
